(19) United States
(12) Patent Application Publication
(10) Pub. No.: US 2015/0088775 A1
(43) Pub. Date: Mar. 26, 2015

(54) METHODS AND SYSTEMS FOR INSPECTION OF INDIVIDUALS

(71) Applicants: Craig McIntire, Sterling, VA (US); Jeff Stephens, Sterling, VA (US); Robert Sterling, Sterling, VA (US)

(72) Inventors: Craig McIntire, Sterling, VA (US); Jeff Stephens, Sterling, VA (US); Robert Sterling, Sterling, VA (US)

(21) Appl. No.: 14/034,182

(22) Filed: Sep. 23, 2013

(51) Int. Cl. G06Q 50/26; G06Q 10/00

(52) U.S. Cl. CPC G06Q 50/265; G06Q 10/00
USPC 705/325

(57) ABSTRACT

The systems and methods described herein attempt to increase traveler throughput, increase officer safety, and increase bystander safety at a security checkpoint. The systems and methods described herein attempt to optimize traveler processing via segregation and pre-information selective targeting in order to allow more effective enforcement activities while facilitating the flow of legitimate trade and travel. The systems and methods implement electronic document readers, gates, and biometrics in an attempt to provide the improved functionality.

### CROSS-REFERENCE TO RELATED APPLICATIONS

This application claims priority to U.S. Patent Application Ser. No. 61/703,891, filed Sep. 21, 2012, which is incorporated by reference in its entirety.

This application is related to U.S. patent application Ser. Nos. ______, ______, ______, and ______, each filed on even date herewith, all of which are hereby incorporated by reference in their entirety.

### TECHNICAL FIELD

The present invention relates generally to inspection of individuals to determine admittance to a location.

### BACKGROUND

U.S. Customs and Border Protection (CBP) is responsible for keeping terrorists, drugs, and weapons out of the United States, while securing and facilitating trade and travel, and enforcing hundreds of U.S. regulations (including immigration and drug laws). CBP handles points of entry along the southern and northern border to curtail the arrive, by foot, of terrorists, criminals, and drugs traveling into the U.S. while facilitating the flow of personnel crossing back and forth for business, education, or pleasure.

Pedestrian traffic at border crossings is processed in a variety of ways depending on the facilities and infrastructure at the port of entry. Most crossings that process large numbers of pedestrians have primary booths (similar to airports). The traveler waits in a line that sometimes extends outside the facility (occasionally to the international border and beyond). Generally, there is a secured sidewalk with limited fixed signage directing travelers from the border directly to the crossing facility. Once they are inside a facility, travelers are either directed to a booth for processing or continue to wait in line until called by a CBP Officer.

A traveler presents documentation to a CBP Officer at a primary processing booth. After the Officer inspects this documentation and makes a determination to either admit or refer the traveler for secondary processing. In some cases, a traveler may be carrying baggage—which will be x-rayed. If a traveler requires additional documentation, such as an I-94, Arrival/Departure Record, the traveler is referred to a permit processing area. In some cases, travelers will proceed directly to the permit processing area. At small volume crossings, permit processing is performed in the primary processing area. At other crossings, a separate line exists for special groups such as school children, the elderly, handicapped persons or bus passengers. Several crossings on the southern border have a SENTRI pedestrian lane, which is designated for pre-approved, low-risk travelers.

Once a traveler is admitted into the United States and all baggage is x-rayed, the traveler exits the facility. Some large volume crossings have dedicated Officers to monitor activity in this area.

Bus processing is an integral part of pedestrian processing since many crossings process bus passengers in the same facility as travelers who walk across the border. When a bus arrives at a crossing, the passengers may disembark from the bus or an officer may board the bus to conduct a primary inspection.

### SUMMARY

The systems and methods described herein attempt to overcome the drawbacks discussed above to increase traveler throughput while also increasing officer safety. The systems and methods described herein attempt to optimize traveler processing via segregation and pre-information in order to allow more effective enforcement activities while facilitating the flow of legitimate trade and travel. The systems and methods implement inspection devices positioned in advance of officer stations, including electronic document readers, gates/kiosks, and biometrics, in an attempt to provide the improved throughput and security.

In one embodiment, a system for inspecting individuals comprises a gate/kiosk subsystem computer configured to receive identifying information from an identification document of an individual; a signage control subsystem computer configured to display a message on a screen that is visible to individuals prior to an inspection; a display subsystem computer configured to present the identifying information from the identification document of the individual; a dashboard system computer configured to receive information related to device defaults, notifications, and heartbeats and to provide control and configuration management of devices; and a backend processing subsystem computer configured to receive additional information about the individual from whom the gate/kiosk subsystem computer received the identifying information from the identification document of the individual.

In another embodiment, a kiosk comprises a display screen configured to display messages; a first document reader configured to read alphanumeric characters from an identification document; and a second document reader configured to receive a transmission from an identification document having a transmitter, wherein the kiosk is configured to transmit information from the identification document received from the first document reader or the second document reader to a computer configured to process the information.

In another embodiment, an inspection system comprises a kiosk comprising a display screen configured to display messages; a document capture device; a biometric reader; a video camera; and an audio input and output device; and a computer located remotely from the kiosk and communicatively coupled to the kiosk, the computer comprising a display screen configured to receive an image and associated data of a document captured by the document capture device, and a live video of an individual at the kiosk received from the video camera; and an audio input and output device configured to send and receive audio signals to the audio input and output device of the kiosk.

In another embodiment, a kiosk comprises a recess for receiving an identification document; a first document reader configured to read alphanumeric characters from the identification document in the recess; and a second document reader configured to receive a transmission from the identification document having a transmitter in the recess, wherein the recess has the first document reader on a first side of the recess and the second document reader on a second side of the recess, and wherein the kiosk is configured to transmit information from the identification document received from the first document reader or the second document reader to a computer configured to process the information.

In another embodiment, a computer implemented method for obtaining biometric information from a user comprises determining, by a computer, whether the user is to provide biometric information through a detecting device prior to arrival at an inspection location; receiving, by the computer, the biometric information of the user from the detecting device; and automatically presenting, by the computer, the detected biometric information to the user as the detected biometric information is received.

In another embodiment, a computer implemented method comprises receiving, by a computer, information from a mobile device of a user prior to arrival at an inspection location, the information comprising an image of an identification document, an image of the user, and information from the identification document of the user; determining, by the computer, a location of the mobile device; and authenticating, by the computer, the user when the mobile device is within a predetermined distance from a facility.

In another embodiment, a computer implemented method comprises requesting, by a computer, a user to provide an identification document; evaluating, by the computer, information from the identification document provided by the user to generate an evaluation result; presenting, by the computer, an available unique indicator for the user after evaluating the identification document; directing, by the computer, the user to wait for further processing upon being called by the presented indicator.

In another embodiment, a signage control system comprises a display screen configured to provide a message to an individual prior to arrival at an inspection checkpoint; and a computer configured to dynamically change a message on the display screen based upon an amount of people at the security checkpoint.

In another embodiment, a signage control system comprises a display screen configured to provide a message to an individual prior to arrival at an inspection checkpoint; and a computer configured to dynamically change a message on the display screen based upon an amount of personnel working at the security checkpoint.

In another embodiment, a system comprises a document capture device configured to capture an identification document of a user; a document reader configured to read a pass of the user; a computer configured to receive the captured identification document and information from the pass of the user, compare the captured identification document with the pass, determine that the pass is submitted for an event within a predetermined time period, and present to a security personnel the captured identification document for verification with the user.

In another embodiment, a system comprises a kiosk configured to request a user to provide an identification document, evaluate information from the identification document, present an available unique indicator to the user, and direct the user to proceed to a designated indicator location to await further instruction; and a display subsystem configured to receive information from the kiosk and receive a selection from an officer of an available user at one of the designated indicator locations.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a system architecture according to an exemplary embodiment.

FIG. 2 illustrates a system overview according to an exemplary embodiment.

FIG. 3 illustrates a gate/kiosk subsystem according to an exemplary embodiment.

FIG. 4 illustrates a pre-primary gate according to an exemplary embodiment.

FIG. 5 illustrates a pre-primary gate according to an exemplary embodiment.

FIG. 6 illustrates a pre-primary gate process according to an exemplary embodiment.

FIG. 7 illustrates a primary gate according to an exemplary embodiment.

FIG. 8 illustrates a system overview according to an exemplary embodiment.

FIG. 9 illustrates a system architecture according to an exemplary embodiment.

FIG. 10 illustrates a process according to an exemplary embodiment.

FIG. 11 illustrates a graphical user interface according to an exemplary embodiment.

FIG. 12 illustrates a graphical user interface according to an exemplary embodiment.

FIG. 13 illustrates a process according to an exemplary embodiment.

FIG. 14 illustrates a kiosk according to an exemplary embodiment.

FIG. 15 illustrates a kiosk according to an exemplary embodiment.

FIG. 16 illustrates a kiosk according to an exemplary embodiment.

FIG. 17 illustrates a system overview according to an exemplary embodiment.

FIG. 18 illustrates a system overview according to an exemplary embodiment.

FIG. 19 illustrates a graphical user interface according to an exemplary embodiment.

FIG. 20 illustrates a graphical user interface according to an exemplary embodiment.

FIG. 21 illustrates a graphical user interface according to an exemplary embodiment.

FIG. 22 illustrates a graphical user interface according to an exemplary embodiment.

FIG. 23 illustrates a graphical user interface according to an exemplary embodiment.

FIG. 24 illustrates a graphical user interface according to an exemplary embodiment.

FIG. 25 illustrates a graphical user interface according to an exemplary embodiment.

FIG. 26 illustrates a graphical user interface according to an exemplary embodiment.

FIG. 27 illustrates a remote kiosk according to an exemplary embodiment.

FIG. 28 illustrates a process according to an exemplary embodiment.

FIG. 29 illustrates a handheld device according to an exemplary embodiment.

FIG. 30 illustrates a system overview according to an exemplary embodiment.

FIG. 31 illustrates a graphical user interface according to an exemplary embodiment.

FIG. 32 illustrates a graphical user interface according to an exemplary embodiment.

FIG. 33 illustrates a graphical user interface according to an exemplary embodiment.

FIG. 34 illustrates a graphical user interface according to an exemplary embodiment.

FIG. 35 illustrates a graphical user interface according to an exemplary embodiment.

FIG. 36 illustrates a process according to an exemplary embodiment.

FIG. 37 illustrates a graphical user interface according to an exemplary embodiment.

FIG. 38 illustrates a graphical user interface according to an exemplary embodiment.

FIG. 39 illustrates a graphical user interface according to an exemplary embodiment.

FIG. 40 illustrates a schematic flow according to an exemplary embodiment.

FIG. 41 illustrates indicators according to an exemplary embodiment.

FIG. 42 illustrates a process according to an exemplary embodiment.

FIG. 43 illustrates a process according to an exemplary embodiment.

FIG. 44 illustrates a schematic flow according to an exemplary embodiment.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments may be substituted for the particular examples described herein and still fall within the scope of the invention.

Although the exemplary embodiments discuss a border crossing configuration, it is intended that the systems and methods can be configured for any security checkpoint where it is desirable to identify the people arriving at the security checkpoint. For example, the systems and methods may be applied to schools, airports, arenas, stadiums, national parks, amusement parks, sporting events, government buildings, office buildings, jails, public transportation, and religious institutions.

In the exemplary embodiment, a border crossing officer inspects a pedestrian traveler to determine whether the traveler should be admitted across the border. However, it is intended that in other embodiments, the traveler can be any individual, and the officer can be any administrator or personnel that is involved in the inspection of the individual. As described in the exemplary embodiment, the traveler may not be enrolled or pre-registered with the inspection system directly, thereby allowing little or no time to process the traveler's documents and information before the traveler arrives in person at a booth attended by the officer. In other embodiments other than border crossings, an individual may attend an event or arrive at a location where an administrator is not aware of the individual's arrival and must inspect the individual upon arrival. For example, a person may purchase tickets to an event, but the security personnel at the event are not sure who is attending the event, as the person may give some or all tickets to other people, who are not pre-registered for the event. The methods and systems described herein allow for inspecting and processing of these individuals.

In the exemplary embodiment of a border crossing, a traveler presents a document. This document can be a Western Hemisphere Traveler Initiative (WHTI) compliant document, a passport, ePassport, passport card, drivers license, border crossing card, enhanced drivers license, permanent resident card, or any other identification document having a machine readable zone (MRZ), radio frequency identification (RFID), barcode, or other scannable or readable elements.

The system can provide numerous functions, including unattended collection of traveler data at facility gate/kiosk systems located in advance of officer inspection locations; capture of electronic document data; capture of ten-print fingerprint biometric data; attended collection of traveler data by officers; use of both fixed workstation and mobile handheld platforms; transmission of collected traveler data to backend systems; initiation of queries about travelers to backend systems and law enforcement systems; receipt and display of traveler data query results, hits, and alarms; guiding travelers in the use of gate systems using signage and gate displays; and monitoring of remote gate/kiosks.

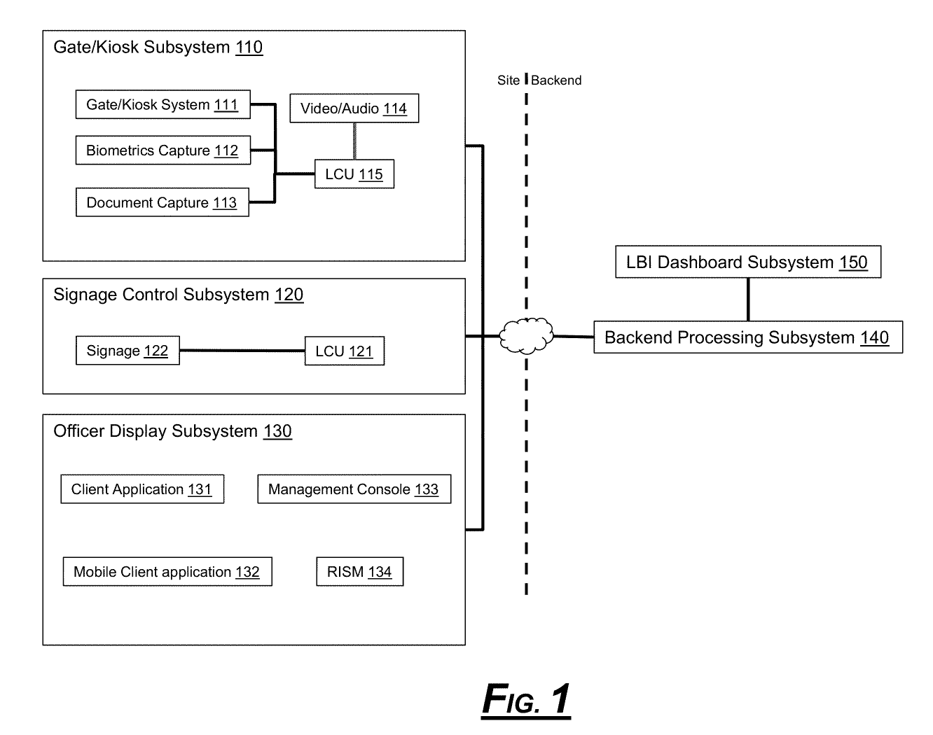

Referring to FIG. 1, an overview of the system is shown according to an exemplary embodiment. The system has five subsystems: gate/kiosk subsystem 110, signage control subsystem 120, officer display subsystem 130, backend processing subsystem 140, and a dashboard subsystem 150. The subsystems described herein can be implemented as one or more specially-programmed computers (e.g., a computer, a server, a database) having a computer-readable medium with computer program instructions that are executed by a processor.

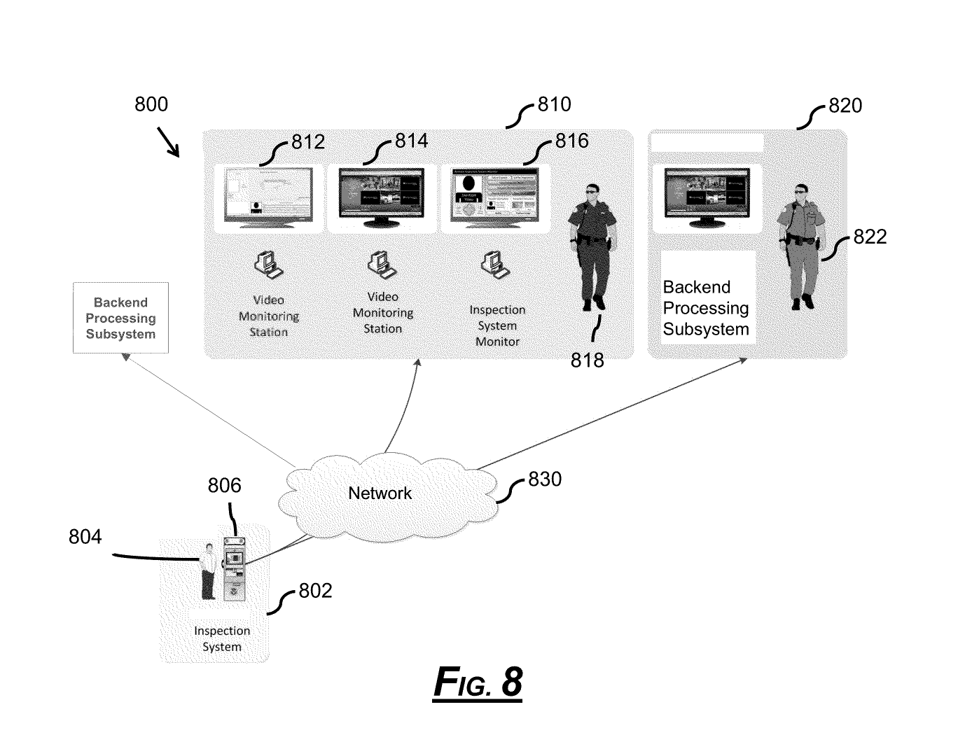

The gate/kiosk subsystem 110 can include a self-contained and independent gate that includes an attached validation station. The validation station contains peripherals that can read WHTI-compliant MRZ and RFID documents, capture traveler fingerprints, and display instructional information to the traveler. The gate/kiosk subsystem 110 can collect traveler data, transmit that traveler data to back-end systems, and controlling gate operations (e.g., open/close). In addition, the gate/kiosk subsystem 110 can provide an interface for external control of selected gate operations (e.g., from the officer display subsystem 130). To support remote operational and maintenance activities, the gate/kiosk subsystem 110 collects and reports configuration, heartbeat, fault, and notification data to the dashboard subsystem 150. For a configuration having a remote kiosk (as shown in FIG. 8), the gate/kiosk subsystem 110 will be equipped video/audio camera that provides video/audio feeds to the officer display subsystem 130.

The gate/kiosk subsystem may have one or more of a plurality of configurations. In one embodiment, the system has gates with attached kiosks containing document and biometric reading devices. This configuration may be used at large ports with high-volume pedestrian traffic. In another embodiment, the system has kiosks containing document reading devices. These kiosks may be used at medium to small sized ports with smaller pedestrian traffic volumes. In yet another embodiment, the system has a kiosk containing document reading, biometric, and camera systems to support processing of pedestrians at remote ports where there may be no officer presence. In still yet another embodiment, an officer may use a mobile device having document reading functionality. In another embodiment, an application may be installed on a mobile device of a user.

As shown in FIG. 1, the gate/kiosk subsystem sends messages to the backend processing subsystem, dashboard subsystem, and officer display subsystem. The gate/kiosk subsystem sends initialization messages to the backend processing subsystem upon gate/kiosk subsystem initialization and includes identification data, current operation mode, and session information used by external components to communicate with the gate/kiosk subsystem. The gate/kiosk subsystem sends document data to the backend processing subsystem that is acquired by a validation station during an automated read of MRZ and RFID of documents. When reading MRZ, the data may include a document image containing the MRZ. The gate/kiosk subsystem sends fingerprint data acquired by the validation station fingerprint capture device to the backend processing subsystem. The gate/kiosk subsystem sends faults, heartbeats, and notifications to the backend processing subsystem and dashboard subsystem to provide operational status of equipment. The gate/kiosk subsystem sends configuration health data to the dashboard to remotely manage hardware and software configurations and convey health statistics (e.g., memory use). The gate/kiosk subsystem sends video and audio from a remote kiosk to the officer display subsystem. The gate/kiosk subsystem sends gate/kiosk subsystem status information (e.g., current state) to the officer display subsystem.

The gate/kiosk subsystem 110 has various components. A gate/kiosk system 111 has an optional physical gate that includes travel sensors, sliding doors, gate indicators, traveler display, validation station (e.g., configured as a kiosk), and a power supply. The gate/kiosk system 111 provides physical control of the gate based on operations and results from validation station processing. The gate system controls the door panels, sensors, indicator lights, and provides mechanism to report functional status. This includes opening and closing the door panels, checking status of sensors for traveler presence in the passage area and changing the symbol displayed on various indicators. Although a kiosk is shown in the exemplary embodiments, it is intended that the kiosk may include any specially-programmed device (e.g., computer) that can perform the functions consistent with the scope of this disclosure.

A biometrics capture device 112 is a peripheral device that can be used to capture traveler biometrics, such as a ten fingerprint slap capture device, iris scanner, retina scanner, or facial recognition scanner. The biometrics capture device 112 is responsible for ten-print fingerprint capture and submission to backend systems. This component is included on primary gate validation stations located in advance of the officer inspection location. Biometrics capture includes interfacing with fingerprint capture and analysis services to capture, segment, analyze quality, and generate templates for specified traveler fingerprints. The traveler supplies a hand “slap” for the hand that was requested by the system to allow the system to capture fingerprint images for processing. The system determines which travelers are eligible for biometric verification and whether there are finger prints available. Quality analysis is performed against the captured fingerprint images in order to increase probability of successful processing in backend biometric systems. Other validation occurs on presented hands, such as which hand is placed when prompted (handedness), missing fingers, etc. In order to facilitate processing, travelers will attempt biometric capture for a configurable number of attempts, with minimal instruction, before the system refers them to an officer (to complete processing). Additionally, travelers will not be required to annotate missing fingers or other exceptions. If an error or time out occurs while travelers are trying to provide capture samples, travelers will finish processing at a booth. In the exemplary embodiment, fingerprint data is not stored locally on the validation station. Although ten-print devices are used, four prints (i.e., slap of each hand requested by the system and no thumbs) is captured.

A document capture device 113 is a peripheral device, or a combination of multiple devices, used to capture document images (e.g., WHTI-compliant documents), read document MRZ, and capture document RFID. The document capture device can use OCR (optical character recognition) functionality to read the scanned MRZ. An MRZ scan can initiate a query against law enforcement databases such as TECS and National Crime Information Center (NCIC). An RFID query can be initiated when an RFID-enabled document enters the vicinity of an RFID reader. In some instances, a manual query is performed in the display subsystem by an officer, using the traveler's name, date of birth, and country of citizenship. The document type may or may not be entered, although the document may not be linked to the traveler when a manual query is performed.

In an attempt to further expedite document scanning, the document capture device 113 captures two types of documents that are electronically read at gate/kiosk systems: MRZ and RFID. As travelers place their documents onto an MRZ reader, the RFID antenna simultaneous attempts to capture and read the document. If the RFID antenna read action finds no data, the MRZ document reader captures the document data. In order to obtain successful RFID reads, documents must be presented with minimal coverage by the hand (travelers will be instructed on placement). RFID antennae will attempt to capture RFID data before documents reach MRZ platens. There may be instances, however, when RFID data is not captured. Additional attempts may be made—with MRZ capture used to mitigate any failure to read RFID data.

A video camera and/or audio microphone and speaker 114 can be used in the remote kiosk configurations. The video/audio feed from the camera installed in the remote kiosk can allow officers to view the traveler's face and their document when it is held up to the camera. The audio feed allows officers to conduct a two-way conversation with the traveler at the remote kiosk.

A lane controller unit (LCU) 115 includes a single board computer, network interface, power supplies, flash drive, and digital I/O board. The LCU 115 may include a middleware component that interfaces with gate/kiosk system and validation station peripherals (e.g., document readers) and communicates with backend processing subsystem 140 to send traveler document information. The middleware framework provides a software architecture that encapsulates common cross-platform functions, such as sending messages to the backend processing subsystem 140 and receiving messages from external systems. The LCU 115 can also periodically collect configuration and health information to transmit to the dashboard subsystem 150 to support configuration and operational management. The LCU 115 has a fingerprint capture service that interfaces directly with fingerprint capture devices to stream preview images, to perform analysis (including segmentation, quality, and handedness), and then to capture an image of the fingerprints. A fingerprint analysis service receives captured fingerprint images and analyzes them in detail, generating additional biometric data, such as segmentation and minutiae. If fingerprint images are insufficient, the service will capture an image of the slap (after a timeout occurs). The service streams fingerprint images to the caller, along with other information about the completion of a read and about the quality of fingerprint data. The fingerprint analysis service packages images into a message for authentication by a fingerprint authentication service, such as IDENT. The LCU 115 has a tag reader application that interfaces with a document RFID capture device to read document RFID tags. The tag reader application interfaces with the RFID reader to read unique RFID tag IDs (TIDs) of WHTI-compliant documents. Once the read operation starts, a buffer is built to hold the TIDs of all RFID tags encountered during that read session. Once a TID is successfully read, it is sent to the caller only once during a read session. Once the read session is terminated, no further RFID reads occur until a new read session is established.

The gate and kiosk components of the gate/kiosk system 111 of the gate/kiosk subsystem 110 can be used in various configurations. For example, the kiosks having document reading devices can be used in the configuration having gates, for example, as a pre-primary gate, discussed below.

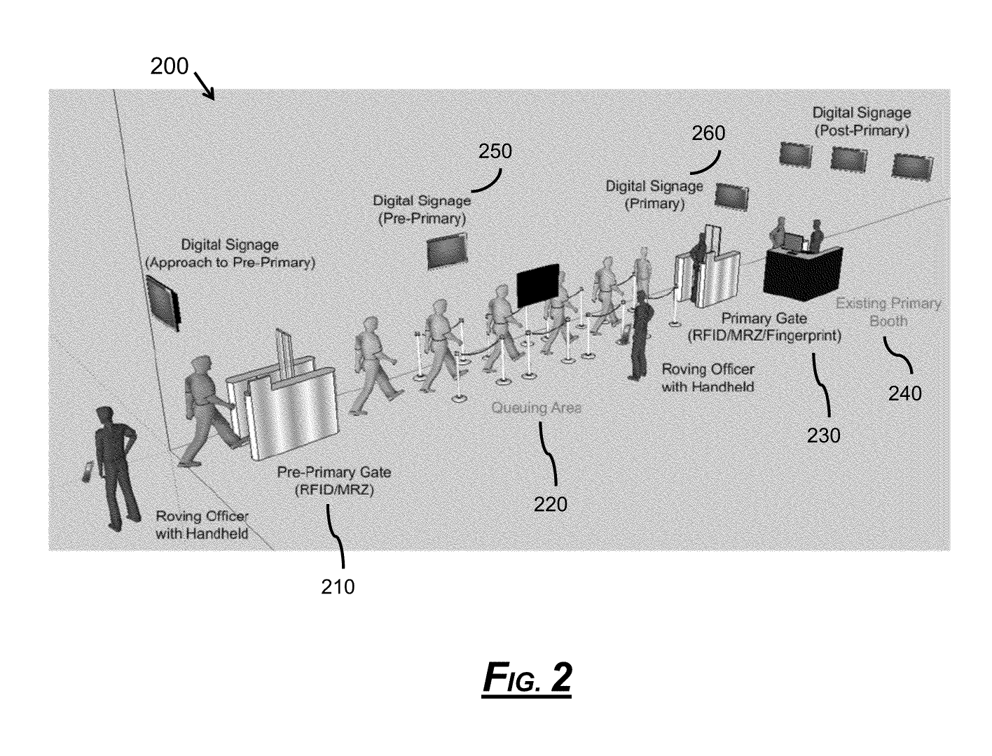

Referring to FIG. 2, an overview of an exemplary configuration is shown. The system 200 has a pre-primary gate/kiosk 210, a queuing area 220, a primary gate/kiosk 230, a booth 240, pre-primary digital signage 250, and primary digital signage 260. The pre-primary gate 210 and the primary gate/kiosk 230 are associated with the gate/kiosk subsystem. The pre-primary digital signage 250 and primary digital signage 260 are associated with the signage control subsystem. The booth 240 is associated with the officer display subsystem. An officer having a mobile device is also associated with the officer display subsystem. A management console (not shown) is associated with the officer display subsystem. The gate/kiosk subsystem, signage control subsystem, and officer display subsystem are each communicatively coupled to a network, in which these subsystems can communicate with the backend processing subsystem and dashboard subsystem.

This configuration has four zones in which the process takes place. First, in an approach to pre-primary zone, the traveler approaches the pre-primary gate/kiosk 210. Second, the pre-primary gate/kiosk 210 through the queuing area 220 is a pre-primary zone. Third, the primary gate/kiosk 230 and the booth 240 are the primary zone. Fourth, after the booth 240 is the post-primary zone.

A traveler enters a facility and views the pre-primary digital signage 250. A roving officer may approach the traveler to initiate queries. The traveler places a machine-readable document (e.g., WHTI compliant document) on a document reader at the pre-primary gate/kiosk 210. The pre-primary gate/kiosk 210 performs basic document validation, sends data to the backend processing subsystem, initiates backend biometric processes in preparation for verification at the primary gate, and allows the traveler to enter into the queuing area 220. The queries are initiated and data is made available to local subscribing systems for alert processing. Query results are cached in the backend processing subsystem upon completion. Initiation of data capture and verification, in advance of the inspection location, increases security by alerting subscribing systems prior to the traveler encountering an officer. Facilitation is increased by the traveler performing the document processing task while the officer performs duties at the inspection location.

The traveler proceeds through the queuing area and views the pre-primary digital signage 250 providing informational content on what to expect next in the process as well as directions on how to interact with gate and kiosk components. The traveler then waits for the next available primary gate/kiosk 230. The traveler enters the available primary gate/kiosk 230 and places the document on the document capture device of the primary gate/kiosk 230. Document data is read and submitted to the backend system for results retrieval.

The officer display subsystem retrieves data from the backend cache of the backend processing subsystem, and the data is displayed on a computer of the officer display subsystem in the booth 240 attended by an officer as well as other subscribing systems attended by officers. The officer is able to review information on the next traveler in line while also processing the current traveler at the booth. If applicable, the traveler will provide fingerprint biometrics to the primary gate prior to arriving at the inspection booth 230. Security is increased by performing biometric verification of the traveler. Facilitation is increased by having the traveler perform the biometric process while the officer performs duties at the booth.

When the officer is ready, the officer will press a button on a graphical user interface of the computer of the officer display subsystem to open the primary gate/kiosk 230 to allow the traveler to approach the booth 240 to complete processing. After the traveler has proceeded to the booth to complete the inspection, the gate/kiosk is made available for the next traveler.

The officer finalizes processing including a brief interview of the traveler. The traveler is admitted to the U.S. or referred to secondary personnel for further processing. The traveler then follows digital signage to proceed to the U.S. or to secondary personnel.

When there are multiple traveling users waiting for a same or similar service, there is a need for a method to organize these traveling users in an efficient manner. The method and system described here can be used in many places where a plurality of users are waiting for a same service, for example, places like airport, travelers at a border, schools, stadiums, office buildings, or any other places having a volume of travelers passing by.

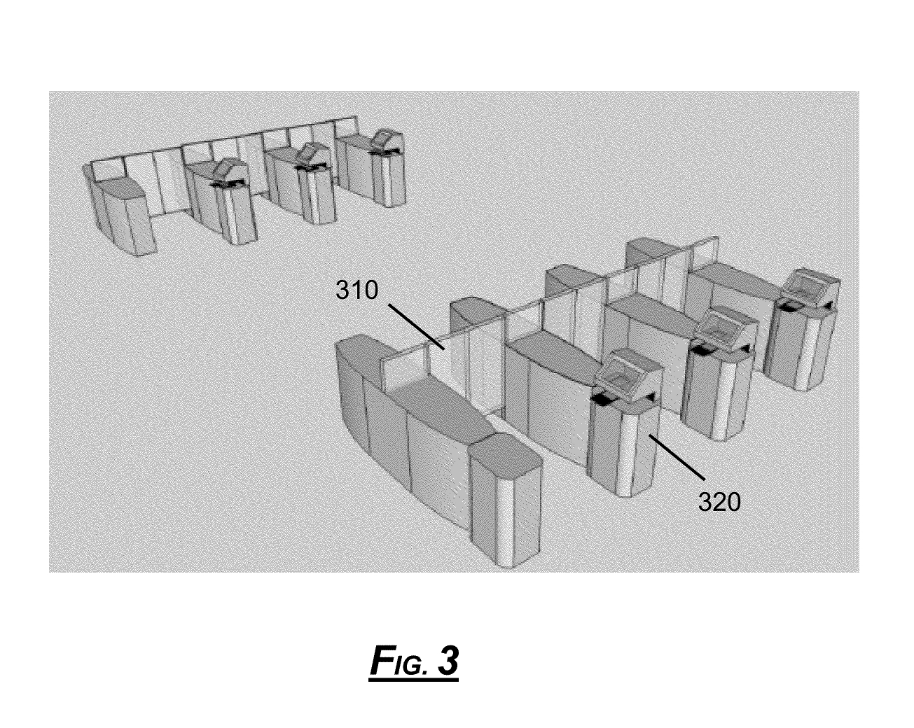

Referring to FIG. 3, a perspective view of a gate/kiosk subsystem is shown according to an exemplary embodiment. The gate 310 includes doors that may open upon receiving a message that the document has been validated. The doors may close after a predetermined period of time or until after a sensor determines that the traveler has passed through the gate. The high-speed public transit style gate systems are capable of processing large numbers of travelers in an expeditious manner and are constructed of sturdy stainless steel for the demanding land border environment. Four foot clear tempered glass door panels provide access control and security for the officers, optimal viewing for officers throughout the facility, and are aesthetically aligned with port infrastructure. The gates can provide ADA compliant features such as a wide-lane passage and accessibility to components from appropriate heights. An indicator light is included on the front of the gate assembly allowing travelers to know when the gate is in service and out of service. A gate system can include a pedestal with a validation station and a pedestal with an empty validation station. Consecutive formation combines the pedestals in order to limit the number of empty validation stations. An additional benefit to a consecutive mounting is a smaller footprint when deployed. The gate system provides cable access points via entry points in the base and a cable path runs lengthwise the distance of the gate underside. Attached to each gate is a validation station 320 providing components for the traveler to interact with during processing.

The validation station 320 can be a stainless steel custom component permanently attached to the gate assembly. An LCD screen can be included as part of the core gate system validation station, providing bilingual instructions and feedback to the traveler as they use the system. Internal to the validation station, and behind locked panel access, is the lane system controller and RFID reader components. While the gate systems used in pre-primary and primary can be constructed of the same gate and validation station configuration, the primary validation station may be configured to include a ten fingerprint capture device. There is no direct relationship between the number of pre-primary gates/kiosks and primary gates/kiosks. Any number of formations may be used to accommodate operational parameters for a particular facility.

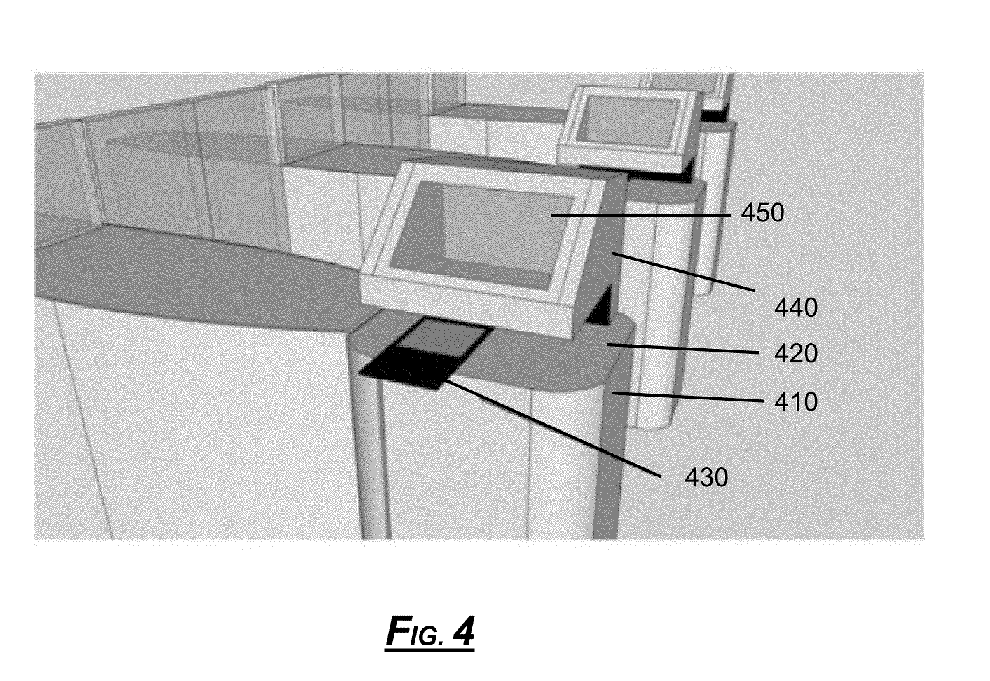

Referring to FIG. 4, a perspective view of a pre-primary kiosk and gate is shown according to an exemplary embodiment. The pre-primary gate is intended to segregate traveler traffic and to initiate backend queries for compliant documents. Traveler data is collected and processed while the traveler quickly moves through the gate/kiosk passage and into the queuing area.

As shown in this view of the pre-primary kiosk, a pedestal portion 410 has a planar portion 420 that includes a document capture device 430. An upper portion 440 extends upward from the pedestal portion 410 and extends over the planar portion 420 such that there remains sufficient space for a traveler to insert a document for scanning while also providing functional protection of the document reader. The upper portion 440 has a surface 450 that may include a window with guidelines (e.g., white lines) to assist the user in aligning a document with the document capture device 430 or a screen to display messages to the traveler.

In this exemplary embodiment, the document capture device 430 is a MRZ document capture device (e.g., ePassport reader) having an LCD monitor above the document capture device. The use of a platen is an alternative to a swipe device and allows the traveler to place the document using different orientations. The traveler will be instructed on preferred placement of the document, with supplemental signage and video content on the screen. The document capture device can be mounted in the same location for both the pre-primary and primary gate/kiosk validation stations. The LCD monitor stand overhangs the capture device and provides sufficient ambient light shielding, via placement and black matte painting, for accurate document processing. The document reader uses sensors and OCR technology to capture the MRZ data for processing.

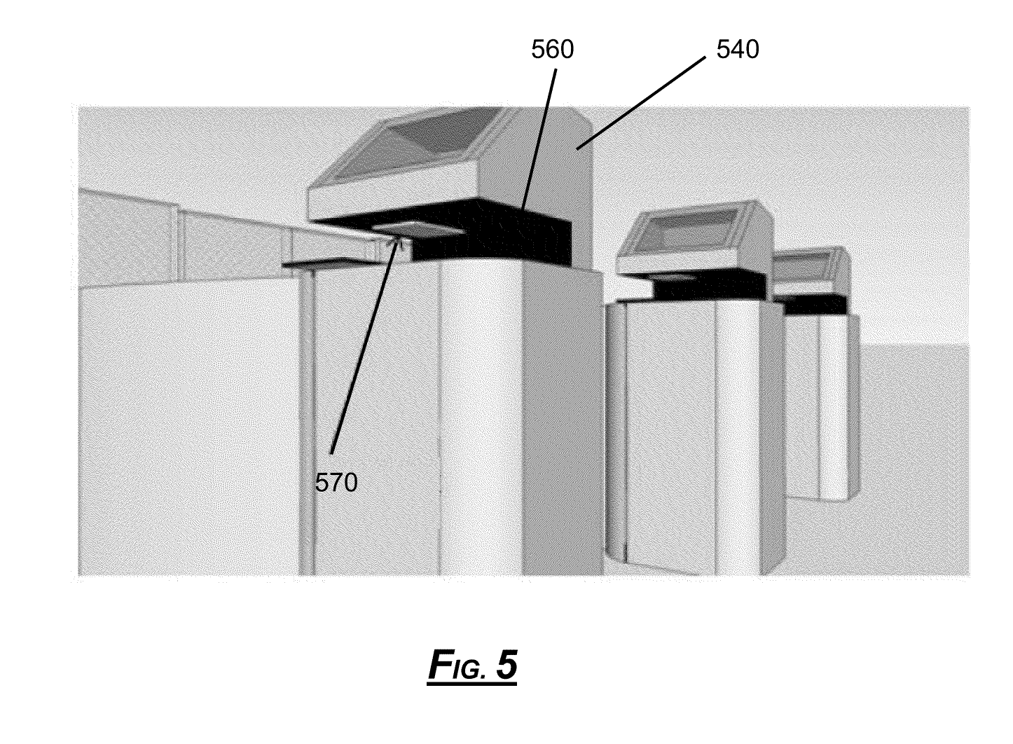

Referring to FIG. 5, an alternative perspective view of the pre-primary kiosk and gate is shown according to an exemplary embodiment. In this view, a lower side 560 of an upper portion 540 is shown. An RFID antenna 570 is mounted on the lower side 560 of the upper portion 540 above the document capture device, thereby allowing the same traveler action to initiate the document read. The RFID reader can be tuned to allow document capture in the area immediately surrounding the platen MRZ reader without capturing documents from adjacent lanes or nearby travelers. As the traveler places their document on the MRZ document capture device, the RFID antenna 570 will capture the document data. The RFID antenna 570 can be mounted under the LCD monitor and connects to an RFID reader mounted inside the validation station. These components can be similar between the pre-primary gate/kiosk and the primary gate/kiosk configurations. Within the gate/kiosk, a computer can serve as the gate/kiosk subsystem LCU. The computer runs an operating system, interfaces with gate/kiosk subsystem peripheral components, and runs the gate/kiosk subsystem software components.

This allows the traveler to simply perform the same action without having to determine which reader is to be used for which type of document. When the traveler approaches the kiosk, the traveler inserts the document for scanning without the need to determine whether the document has RFID or MRZ. By placing the document between the RFID antenna 570 and a document capture device, the system can check for RFID. If the document does not have RFID, the system will scan the document using the document capture device.

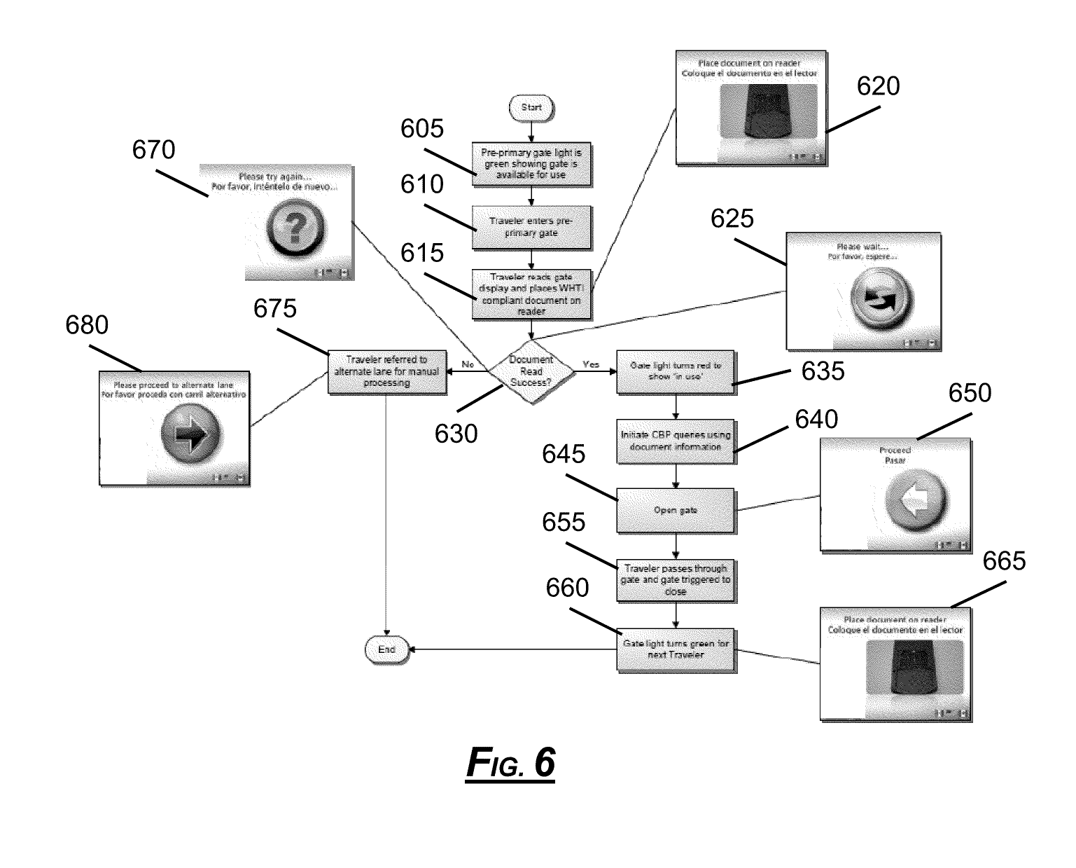

Referring to FIG. 6, an exemplary process for a pre-primary gate is shown. In step 605, a pre-primary gate is green showing that the gate is available for use. In step 610, a traveler enters the pre-primary gate. In step 615, the traveler reads the gate display and places a document (e.g., WHTI complaint document) on a reader. A screen 620 displays instructions to “Place document on reader” and shows a video of the reader. A screen 625 displays that the system is processing and says “Please wait.” In step 630, it is determined whether the document read succeeded. If the document read succeeded, in step 635, the gate light turns red to show that it is “in use.” In step 640, queries are initiated using document information. Queries include document submission to backend subsystem components for traveler lookup and status, initiation of biometric processing for traveler verification at the primary gate, and distribution of information to subscribing officer display subsystems in advance of the inspection location. In step 645, the gate is opened. A screen 650 instructs the traveler to “Proceed” and shows an arrow pointing in the direction to proceed. In step 655, the traveler passes through the gate and the gate is triggered to close. In step 660, the gate light turns green for the next traveler. A screen 665 displays instructions to “Place document on reader” and shows a video of the reader. If the document read did not succeed in step 630, a screen 670 states “Please try again.” In step 675, the traveler is referred to an alternate lane for manual processing. A screen 680 instructs the traveler to “Please proceed to alternate lane” and shows an arrow pointing in the direction to proceed.

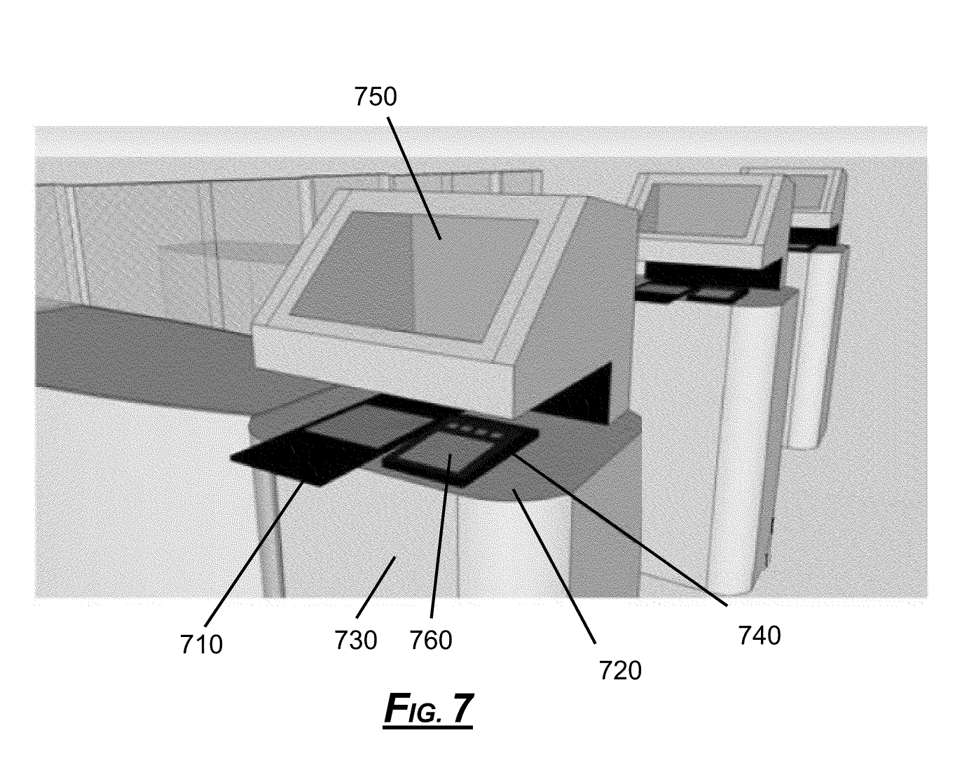

Referring to FIG. 7, a perspective view of a primary kiosk and gate is shown according to an exemplary embodiment. The primary gate can be the same configuration as the pre-primary gate, but in this exemplary embodiment, the primary gate includes a ten fingerprint slap capture device 710 for fingerprint biometric processing prior to arrival at the booth. Although the exemplary embodiment of FIG. 7 recites the use of a fingerprint biometric, it is intended that any biometric capture and recognition process can be used. The fingerprint capture device 710 is positioned on a planar surface 720 of a pedestal portion 730. The fingerprint capture device 710 is positioned proximate to a document capture device 740. The fingerprint device is intended to allow for simple collection of fingerprints from selected travelers. Travelers will submit fingerprints for the right hand for processing as part of a biometric capture process. The fingerprint capture device 710 is made of metal and provides a heated platen to reduce any halo effect from warm fingers. Additionally, a silicon pad is installed over the platen to increase durability and enhance contrast ratio (e.g., for dry fingers). The fingerprint capture device 710 implements additional measures (such as green lights) for filtering ambient light during the capture sequence.

In this exemplary embodiment, the fingerprint capture device 710 is a fingerprint slap capture device 740 that can collect one or more of user's fingerprints. The fingerprint slap capture device 740 includes a sensor 760 that can sense and record a user's fingerprints when the user places his/her fingers on the sensor 760. A screen 750 can display capture results of the fingerprints and display instructions accordingly. In one example, when the obtained fingerprints at the sensor 760 are clear enough and satisfies pre-stored criteria, the screen 750 may display green checks for each fingerprint to indicate all fingerprints pass the criteria. In another case, when one or more of the obtained fingerprints at the sensor 760 is not clear or does not meet the pre-stored criteria, the screen 750 may display a red X for each fingerprint that is not clear to indicate those fingerprints do not pass the criteria. If a fingerprint receives a red X, however, the system will not ask the traveler to recapture that fingerprint. In addition, the screen 750 may display some instructions to the user, providing feedback and/or suggestions regarding the fingerprint capture. For example, the instructions may be “please press harder,” “please clean your fingers and press again,” “your fingers are too dry,” “your fingers are too wet,” etc. The display of the capture result and the instructions on the screen 750 can help the traveler to adjust his/her fingers for improving the fingerprint quality and meeting the criteria in a very efficient way. A traveler does not need to be familiar with the fingerprint capture device or how to best use the device. As the fingerprint capture device is capturing the fingerprints of the traveler, the traveler received real-time feedback on the screen, which can allow the traveler to adjust pressure and placement. The system does not ask for a new capture when there is an insufficient or missing fingerprint capture, so the system can allow for a faster processing of the traveler. Also, a traveler who uses the fingerprint slap capture device frequently can remember a preferred pressure and a preferred degree of drying of the user's fingers for ensuring a good quality of fingerprint capture. In order to increase facilitation, any errors encountered by the traveler at the primary gate during fingerprint processing will result in the traveler completing biometric verification in attended mode with the officer at the booth.

Biometric information refers to identifications of humans by their characteristics or traits. Biometrics, include, but are not limited to, fingerprint, face recognition, hand geometry, and iris recognition, can be used for identification and access control. Many systems, e.g., systems applied to schools, airports, arenas, stadiums, office buildings, and religious institutions, may have a function of capturing biometric data of incoming and outgoing people. For example, a system at selected sites along the southern U.S. border is capable of verifying a traveler's identity through fingerprint capture, by means of the Automated Biometric Identification System (IDENT) database.

The system has a remote inspection system 810 at a port of entry and a remote inspection system monitor 820 at a processing center located remotely from the port of entry.

Referring to FIG. 8, a system 800 for access control is shown according to an exemplary embodiment. The system 800 comprises one or more subsystems, e.g., an inspection system 802, a remote inspection system at an officer display subsystem 810, and a video monitoring station 820 at a location at a distance from the port. These subsystems in the system 800 are communicatively coupled by a network 830. The network 830 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. Accordingly, the inspection system 802 connected to other subsystems via the network 830 may be a local system or a remote system.

The inspection system 802 may include a kiosk 806 for inspecting a traveler 804 for access control or identifications. In one example, the inspection system 802 is a gate/kiosk subsystem for collecting the traveler's 804 fingerprints. The collected fingerprints can be used either for comparing with fingerprints on file or for record to be used in the future. In one embodiment, inspection system 802 is a gate/kiosk subsystem including a gate and a kiosk 806.

The officer display subsystem 810 may include video monitoring stations 812, 814 and an inspection system monitor 816. An officer 818 can monitor circumstances around the inspection system 802 using the video monitoring stations 812, 814. The officer 818 can also receive and monitor the traveler's 804 interactions with the kiosk 806. In one situation, the officer 818 can meet the traveler 804 in person. In another situation, the officer 818 can talk to on a phone. In another situation, the officer 818 can see the traveler 804 through a camera on the kiosk 806.

In one embodiment, the traveler initiates the system by placing their document on the reader. The traveler presses a button to initiate the inspection process. The officer 818 may request the traveler 804 to scan his/her documents on the kiosk 806 or provide information verbally via the audio device or visually via the video interface. Once the officer 818 obtains personal information of the traveler 804 based on the documents and stored information associated with the documents, i.e., associated with the traveler 804, the officer 818 can determine whether to request some biometrics, e.g., fingerprints, from the traveler 804. The stored information associated with the documents may be stored either in the officer display subsystem 810 or in the backend processing subsystem 820. If fingerprints are needed, the officer 818 requests the traveler 804 to provide his/her fingerprints via the kiosk 806. Then the fingerprints provided by the traveler 804 can be sent to a backend processing subsystem for comparison and analysis. The officer 818 can perform further access control based on a feedback received from the backend processing subsystem.

The backend processing system may be responsible for database retrieval and data analysis based on information sent by the officer display subsystem 810 or directly collected at the inspection system 802. An officer 822 may be responsible for viewing and analyzing facility video surveillance and traveling to the facility for remediation of any issues encountered with the traveler 804.

In one embodiment, the officer 818 determines to request fingerprints from the traveler 804. First, the officer display system 810 sends a fingerprint query to the backend processing subsystem. The backend processing subsystem, upon checking whether there are available fingerprints related to this traveler 804 on record for user authentication, sends fingerprint processing commands to the inspection system 802 to inform whether to capture fingerprint biometrics for the current traveler 804. Then, the inspection system 802 sends fingerprint data acquired by a fingerprint capture device 806 to the backend processing subsystem. Finally, the backend processing subsystem sends results of fingerprint queries to the officer display subsystem 810 confirming the identification of the traveler 804.

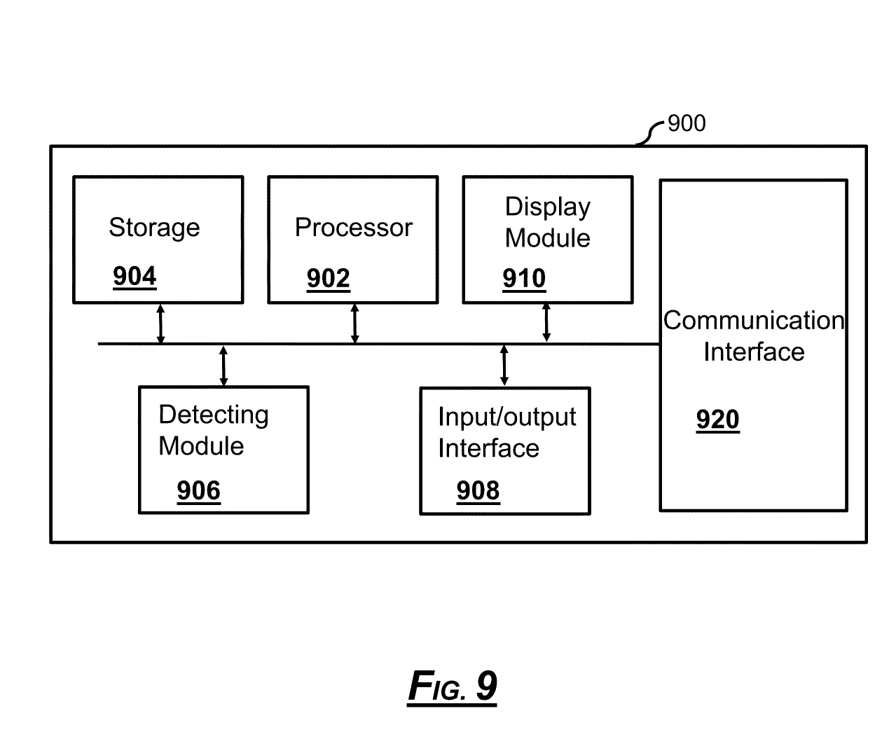

FIG. 9 illustrates a schematic diagram illustrating the basic components of an example architecture of a machine 900 for collecting biometric information according to an exemplary embodiment. The machine 900 includes a processor 902, storage 904, detecting module 906, input/output (I/O) interface 908, a display module 910, and a network interface 920. The processor 902 may be any type of processor capable of executing instructions for performing functions associated with the machine 900 and the features associated with the claimed embodiments. Storage 904 may comprise both volatile memory that stores currently executing instructions/data and non-volatile memory for storing persistent data (e.g., a hard drive).

The detecting module 906 can detect an input from a user via the I/O interface 10P408. The input may be a keyboard input, fingerprint, MRZ or RFID embedded in a user's document, etc. Accordingly, the I/O interface 908 may be a keyboard, a sensor of a fingerprint reader, a sensor of a document reader, etc.

The display module 910 can display information to a user via the I/O interface 10P408. In an embodiment of a fingerprint capture, the information displayed may include capture results of the fingerprints, instructions related to the fingerprint capture, greetings, etc. Accordingly, the I/O interface 908 may be a screen for displaying the information.

The network interface 920 serves as a communication platform that enables the machine 900 to communicate with a network, e.g., the network 830 shown in FIG. 8. In an embodiment of a fingerprint capture, the network interface 920 enables the machine 900 to send the captured fingerprints to the officer display system 810 and/or a backend processing system 820 via the network 830 in FIG. 8.

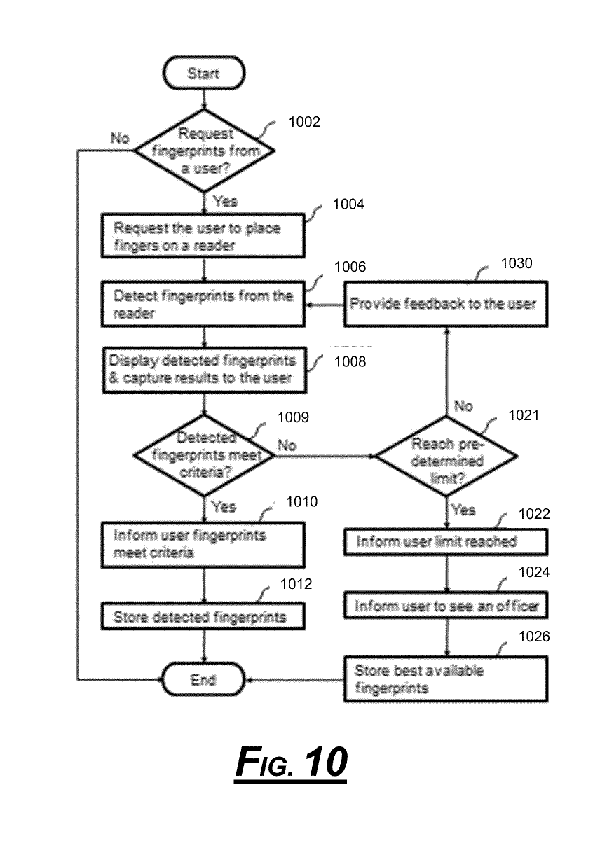

FIG. 10 depicts a flowchart describing a process for collecting fingerprints according to an exemplary embodiment. One of ordinary skill in the art will recognize that the process may be written using any type of programming language and converted to machine readable instructions. These instructions may be stored in the storage 904 and executed by the processor 902 of the machine 900. A process for collecting biometrics other than fingerprints can be similar to the process.

At step 1002, the process determines whether to request fingerprints from a user. This may be determined by an officer based on obtained information related to the user. For example, if the user submits an RFID which matches a profile in a database, the officer can access information in the profile from the database to check whether there exists a record of fingerprints associated with this profile. If so, the officer can request fingerprints from the user and determine whether the fingerprints provided by the user matches the fingerprints stored in the record. This can be used as user authentication and access control. Otherwise, if there is no record of fingerprints associated with the profile, the officer can either request new fingerprints from the user for record or determine not to request fingerprints for fast processing. The officer can also request other biometric information from the user as an addition or alternative to the fingerprints. In one embodiment, the determining process at 1002 can be performed by a machine, e.g., by the processor 902 in the machine 900, instead of an officer.

If it is determined not to request fingerprints at 1002, the process goes to the end. In that scenario, other biometrics may be requested, or no more biometric is requested for fast processing.

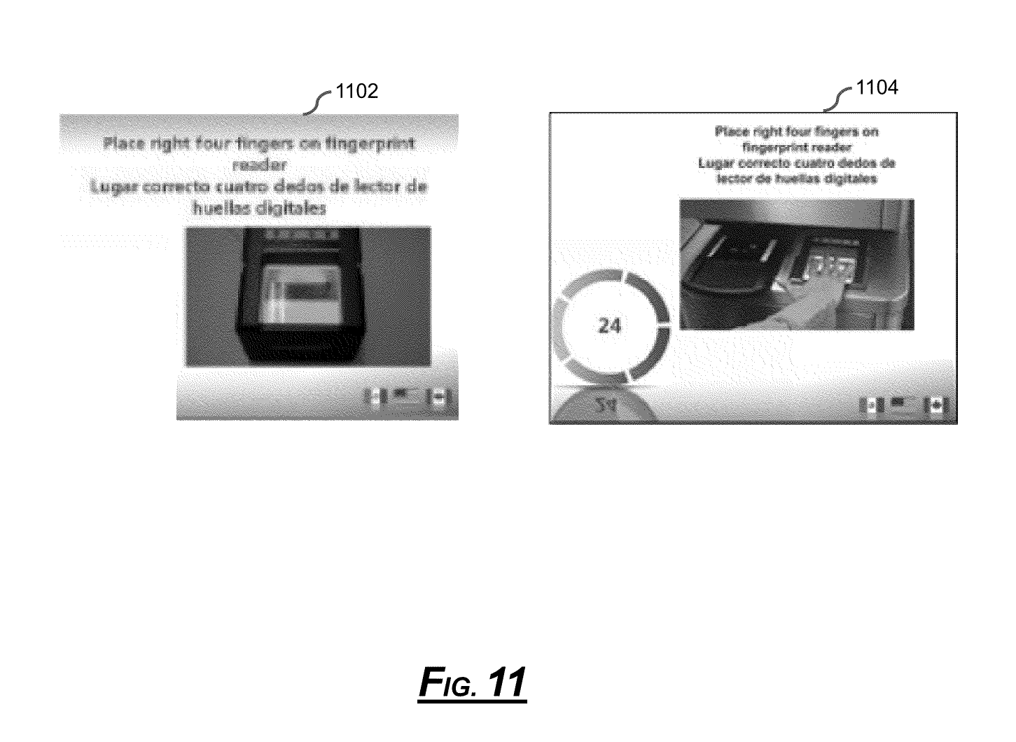

Otherwise, if it is determined to request fingerprints at 1002, the process proceeds to 1004 to request the user to place fingers on a reader, a sensor that can sense and record fingerprints of the fingers on it. FIG. 11 illustrates interactions between a reader of a fingerprint collecting machine and a user according to an exemplary embodiment. As illustrated in 1102, the machine requests the user to place fingers on the reader, by displaying “Place right four fingers on fingerprint reader” with its corresponding Spanish translation shown below. Upon seeing the instruction, a user places right four fingers on the fingerprint reader as shown in 1104.

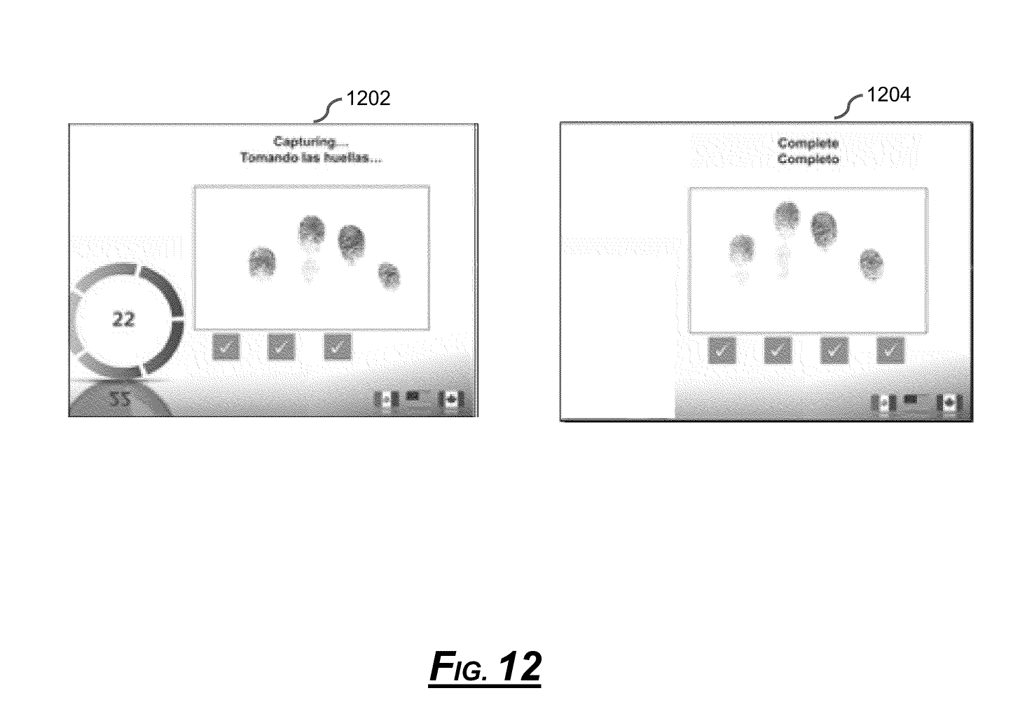

The process then moves to 1006 to detect fingerprints from the reader upon the user placing his/her fingers on the reader. At 1008, the detected fingerprints and the capture results can be displayed to the user, e.g., via the screen. FIG. 12 illustrates capture results of fingerprints displayed on a fingerprint collecting machine according to an exemplary embodiment. As shown in 1202, as the machine captures the fingerprints, four fingerprints are shown on the screen, along with three green checks displayed corresponding to the left three fingers to indicate satisfied quality (e.g., in a condition that the fingerprints can be compared to fingerprints of record) of the three fingerprints. In 1204, while the machine finishes capturing the fingerprints, four fingerprints are shown on the screen, along with four corresponding green checks to indicate satisfied quality of all of the four fingerprints. In case a fingerprint's quality is not good enough to be satisfied by the machine, a red X may be shown correspondingly, in place of a green check.

The process then moves to 1009 to determine whether the detected fingerprints meet some criteria pre-determined at the machine. For example, the criteria may require at least three of the four fingerprints must be clear and complete enough to receive green checks. The criteria may be pre-determined at the machine and may also be modified from time to time. The machine here may determine whether these are fingerprints of a left hand or right hand, e.g., based on recognition of a pattern of the fingerprints.

If the criteria are met at 1009, the process goes to 1010 to inform the user that the fingerprints have been captured. For example, the machine can display a phrase “fingerprints captured successful” on the screen. In other cases, the machine may inform the user with a speech, a voice, a beep, a displayed icon, etc. Then the detected fingerprints are stored at 1012. In one example, the stored fingerprints may be used to match with pre-existing fingerprints on record for user authentication, to ensure the user holding the documents is the same user associated with the documents on record. In another example, the stored fingerprints may be used for record and for future authentication. The process then goes to the end.

Otherwise, if the criteria are not met at 1009, the process goes to 1021 to determine whether a pre-determined limit is reached. The pre-determined limit may be a time limit of processing the fingerprints, or a maximum number of trials for the user to provide the fingerprints. For example, if the machine allows no more than three trials of providing fingerprints, it is determined at 1021 that whether the user has tried three or more times.

If the pre-determined limit is not reached at 1021, or referring to the previous example, if the user has not tried three times, the machine provides feedback and/or instructions to the user at 1030. The feedback can help the user to adjust his/her fingers and provide fingerprints with a better quality next time. For example, the instructions may be “please press your pinky harder,” “please clean your fingers and press again,” “your fingers are too dry,” “your fingers are too wet,” etc. The user can follow the instruction accordingly. The user may also compare the fingerprints of good quality with those of poor quality, based on fingerprints and capture results displayed on the screen. Therefore, the user can have a better idea how to modify his/her fingers for recording fingerprints next time. Then the process goes back to 1006 to detect again fingerprints from the reader upon the user placing his/her fingers on the reader again based on the feedback/instructions.

Otherwise, if the pre-determined limit is reached at 1021, or referring to the previous example, if the user has tried three times, the machine informs the user that the pre-determined limit is reached at 1022. For example, the machine may display a phrase “maximum limit of trials reached” on the screen, or inform the user by a speech, a voice, a beep, a displayed icon, etc. In addition, the machine may optionally inform the user to see an officer or wait for an officer at 1024. The machine may also optionally store the best available fingerprints at 1026. The process then goes to the end.

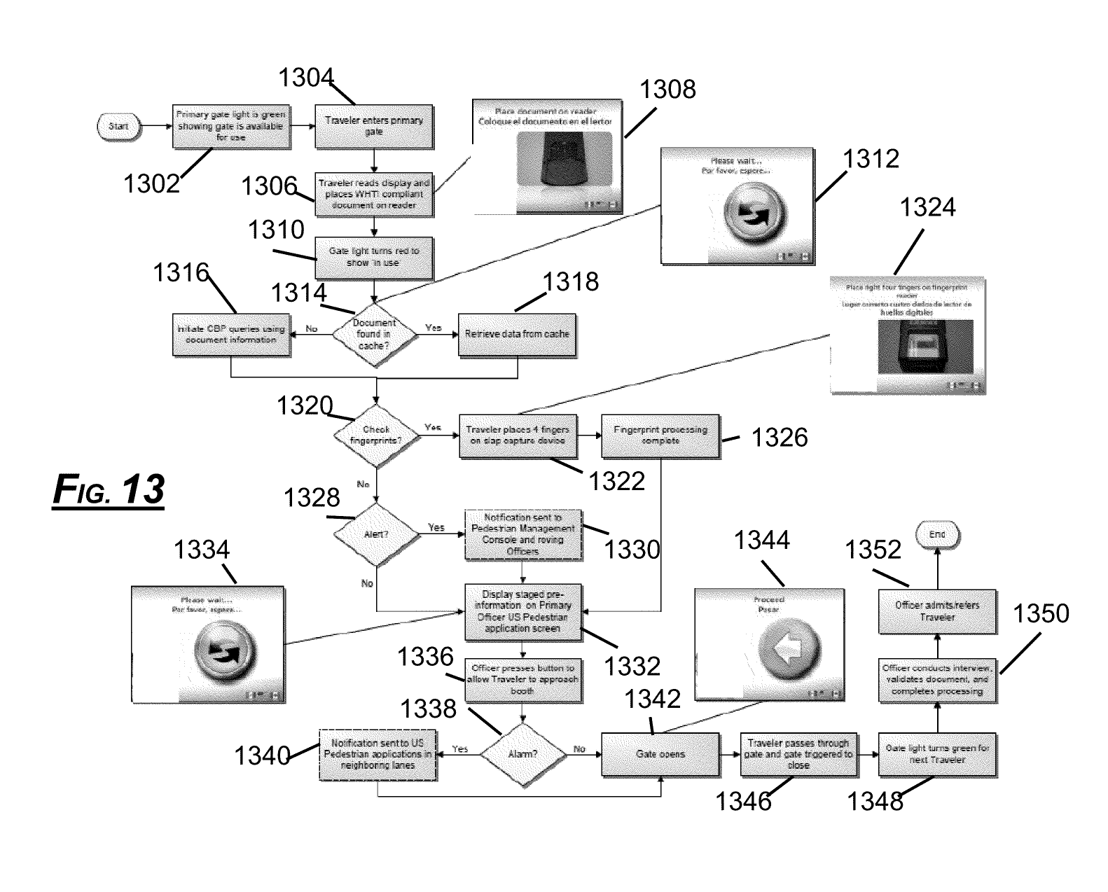

Referring to FIG. 13, an exemplary process for a primary gate is shown. In step 1302, a primary gate light is green showing the gate is available for use. In step 1304, the traveler enters the primary gate. In step 1306, the traveler reads the display and places a document (e.g., WHTI compliant document) on a document reader. A screen 1308 instructs to “Place document on reader” and shows a video of the document reader. In step 1310, the gate light turns red to show “in use.” A screen 1312 states “Please wait” as the system processes. In step 1314, it is determined whether the document is found in the cache. Data will be available in the cache if the document was successfully read earlier in the process at a pre-primary gate/kiosk. In step 1316, if the document is not found, then queries are initiated using document information. In step 1318, if the document is found, then the data is retrieved from the cache. In step 1320, it is determined whether to check for fingerprints. If yes, then in step 1322, the traveler places four fingers on a slap capture device. A screen 1324 says “Place right four fingers on fingerprint reader” and shows a video of the fingerprint reader. In step 1326, the fingerprint processing is complete. If no fingerprints are to be checked, in step 1328, it is determine whether to issue an alert. If so, in step 1330, a notification is sent to various display subsystem components such as the management console and roving officers. In step 1332, the client application screen displays staged information. A screen 1334 instructs the traveler to “Please wait.” As the information is available on the officer display subsystem at the booth, the officer may review the next traveler's information prior to their arrival at the inspection booth. In step 1336, an officer presses a button to allow the traveler to approach the booth. In step 1338, it is determined whether to activate an alarm based on traveler status information. If yes, then in step 1340, a notification is sent to client applications in neighboring lanes. If no, then in step 1342, the gate opens. A screen 1344 says “Proceed” and directs the traveler with an arrow pointing which way to proceed. In step 1346, the traveler passes through the gate and the gate is triggered to close. In step 1348, the gate light turns green for the next traveler. In step 1350, the officer conducts an interview, validates the document, and completes processing. In step 1352, the officer admits or refers the traveler.

The validation station components, including the kiosk components described above in FIGS. 3-5 and 7, can be mounted inside a stainless steel enclosure with access controlled by means of a locked panel. Network, power, and fire system cable routing can be provided via access points and pathways under the gate pedestal and validation station.

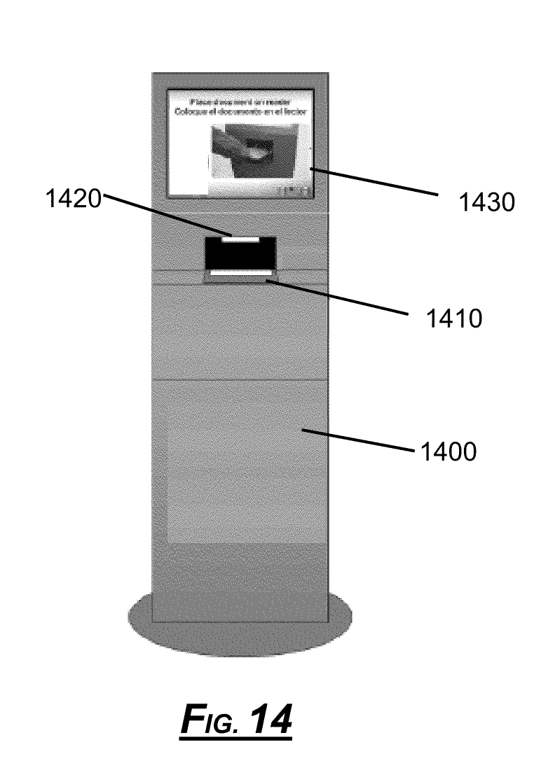

The pre-primary gate and the primary gate each can have a machine or kiosk for checking travelers' documents, biometrics, user identifications, etc. As shown in FIG. 14, a front view of a standing kiosk 1400 is shown according to an exemplary embodiment. The kiosk 1400 may house a document reader 1410, RFID reader 1420, and an LCD screen 1430 providing bi-lingual instructions and feedback to the traveler as they use the system. The document reader 1410 and the RFID reader 1420 may be in a similar configuration to the gate and kiosk described above. The document reader 1410 may include an MRZ reader for reading travelers' documents like a border crossing card, etc. The RFID reader 1420 may read any device of a traveler having an RFID capability, e.g., an enhanced driver's license, passport card, or border crossing card, a cell phone, or a toll device on a traveler's car. The LCD screen 1430 can provide information and/or instructions to inform the traveler to perform a next step according to the processes described above. For example, after a traveler provides requested documents and/or biometrics on a kiosk 1400 located at a primary gate, the LCD screen 1430 on the kiosk 1400 may inform the traveler to either wait for the primary officer associated with the primary gate in a one-to-one mode, or wait for the next open indicator in a many-to-many/on-deck mode.

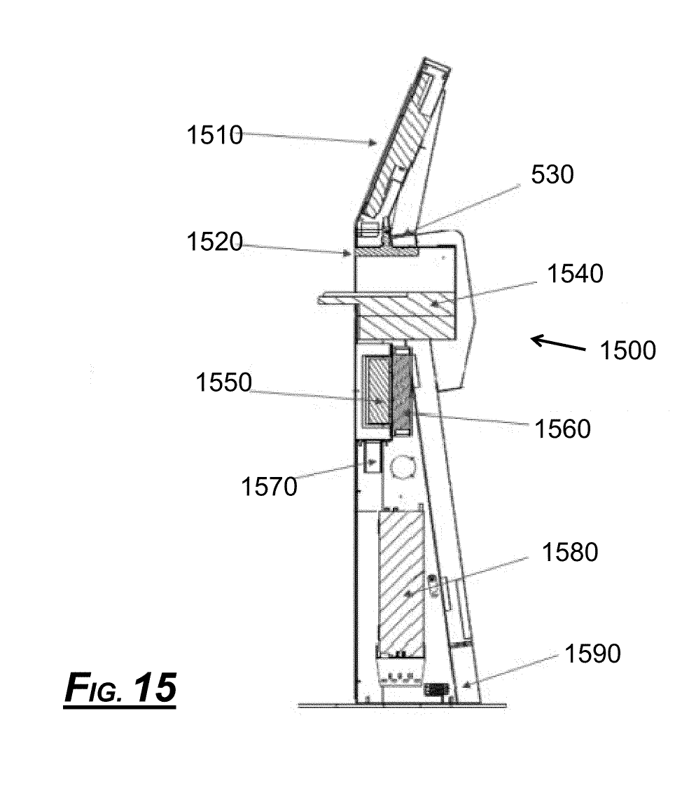

Referring to FIG. 15, a cross-sectional side view of a standing kiosk 1500 is shown according to an exemplary embodiment. The kiosk 1500 has an LCD display 1510, an RFID antenna 1520, an RFID antenna cable 1530, a document reader 1540, a power switch 1550, an RFID reader 1560, an RFID reader power supply 1570, a CPU 1580, and a power strip 1590.

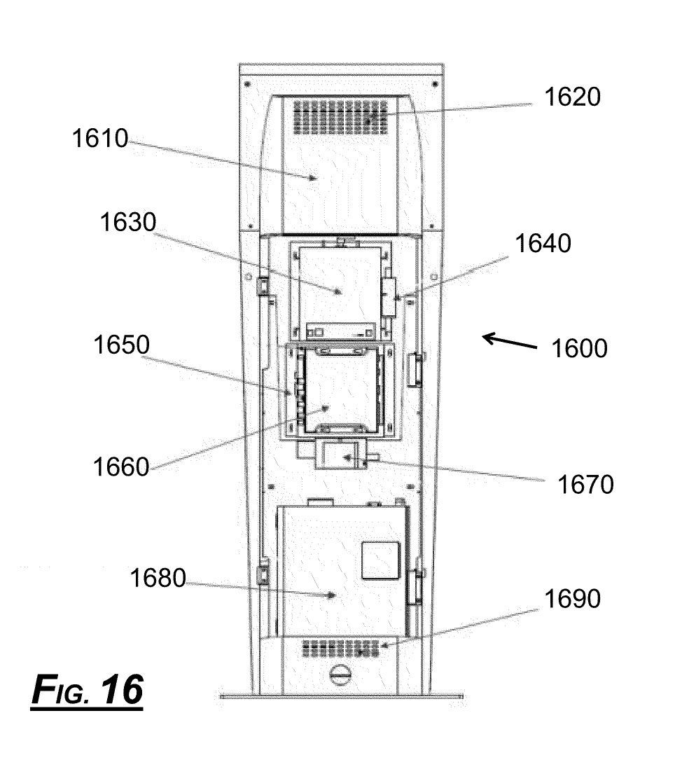

Referring to FIG. 16, a rear view showing components of a standing kiosk 1600 is shown according to an exemplary embodiment. The kiosk 1600 has an LCD display 1610, LCD vents 1620, a document reader 1630, a document reader power supply 1640, a power switch 1650, an RFID reader 1660, an RFID reader power supply 1670, a CPU 1680, and CPU vents 1690.

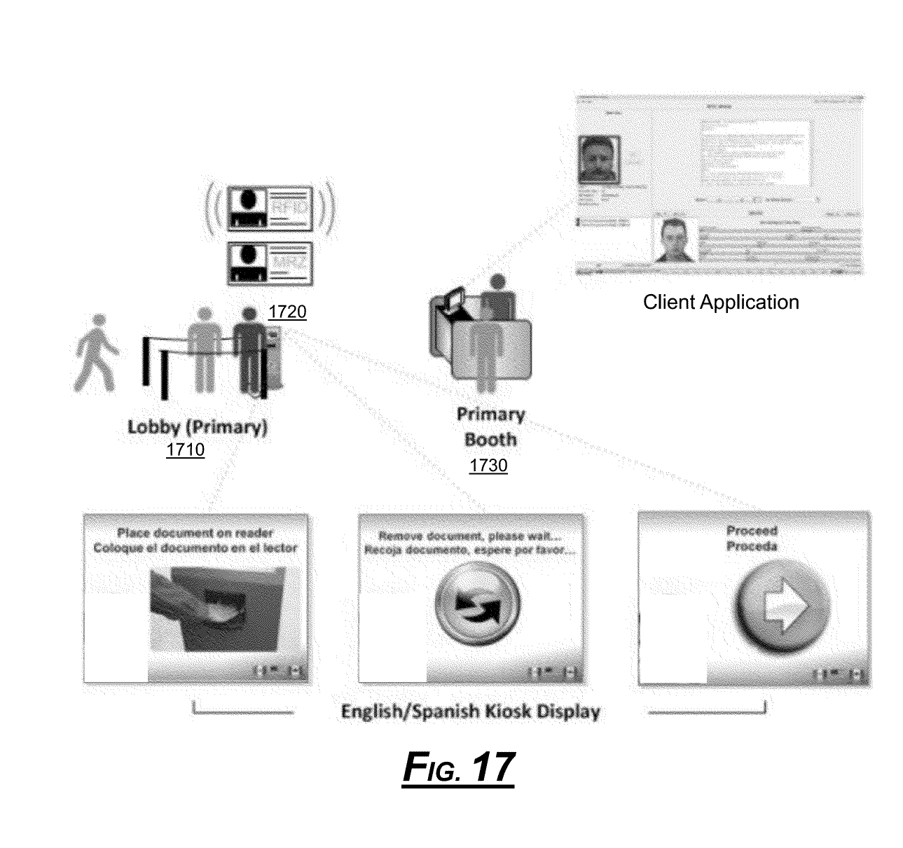

Referring to FIG. 17, an overview of an alternative exemplary configuration is shown. The system has a lobby 1710, a kiosk 1720 and a primary booth 1730. This system may optionally include digital signage, a mobile device, and an alternate display subsystem such as management consoles and mobile devices. The traveler interacts with the kiosk 1720 in the lobby 1710 using an RFID document, document with MRZ, or other document. Information about the traveler is provided to an officer in the primary booth 1730 that uses a client application to understand any risks associated with the traveler and expedite the process for those travelers with little or no risk. In a configuration where there are a plurality of kiosks 1720, the officer in the primary booth 1730 can call upon a traveler from one or more kiosks 1720 to proceed to the primary booth 1730 for further inspection. In one embodiment, an officer, such as a trainee officer, may choose to select those travelers who present little or no risk. In another embodiment, a more experienced officer may choose to select travelers who pose a greater risk or may be considered armed and dangerous. In yet another embodiment, an officer may select the next available traveler to minimize waiting time for travelers. By using these systems and methods, the officers can have more time to process the information before encountering a traveler, and this preparation can add safety to their procedures. Additionally, these systems and methods can allow for a more efficient processing of travelers.

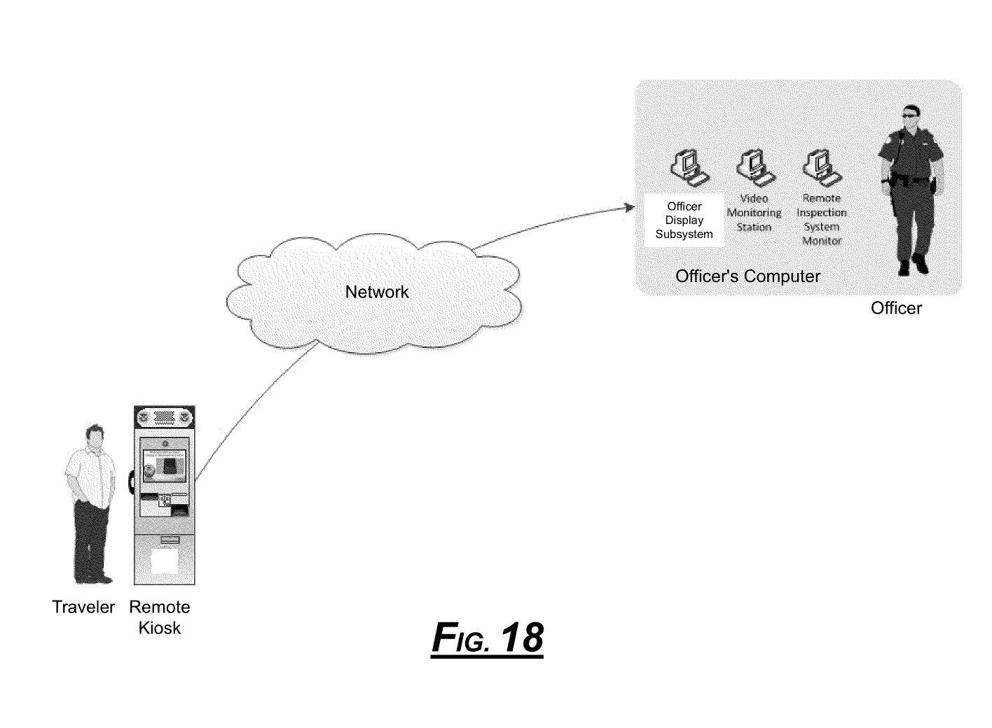

A remote kiosk may be used for an officer to authorize a traveler from a different room, building, or location. As shown in FIG. 18, the remote kiosk and a client application on the officer's computer can communicate via a network, such as the internet. An exemplary process follows. A traveler enters a facility and initiates an inspection by placing a document on a reader or pressing a green button on a remote kiosk. An officer is alerted to an inspection in process via a display subsystem monitor application. The document is read and queries are initiated. The query results are displayed on a client application at the officer's computer. The officer can communicate by 2-way audio and 1-way video with the kiosk via the display subsystem monitor application. The traveler is instructed to pick up the phone for an audio inspection. The officer interviews the traveler and, if applicable, informs the traveler to submit fingerprint biometrics. If applicable, the traveler submits right hand slap fingerprint biometrics. The officer reviews results in the client application, finalizes the interview, and determines admissibility. The officer presses “admit” or “refer” on the client application and informs the traveler of the next steps. The kiosk resets and is ready for the next traveler.

The remote configuration comprises two components: the Remote Inspection System (RIS)/kiosk and the Remote Inspection System Monitor (RISM). The RISM has a processor, a touch-screen display, and runs a RISM application used to monitor and control the remote kiosk. It may be located at a remote facility and is used by officers to support the inspection process. The RIS kiosk can be configured with the same document reader and fingerprint components described above. In addition, a video/audio camera is added to the kiosks to provide video and audio feeds between the officer and the traveler.

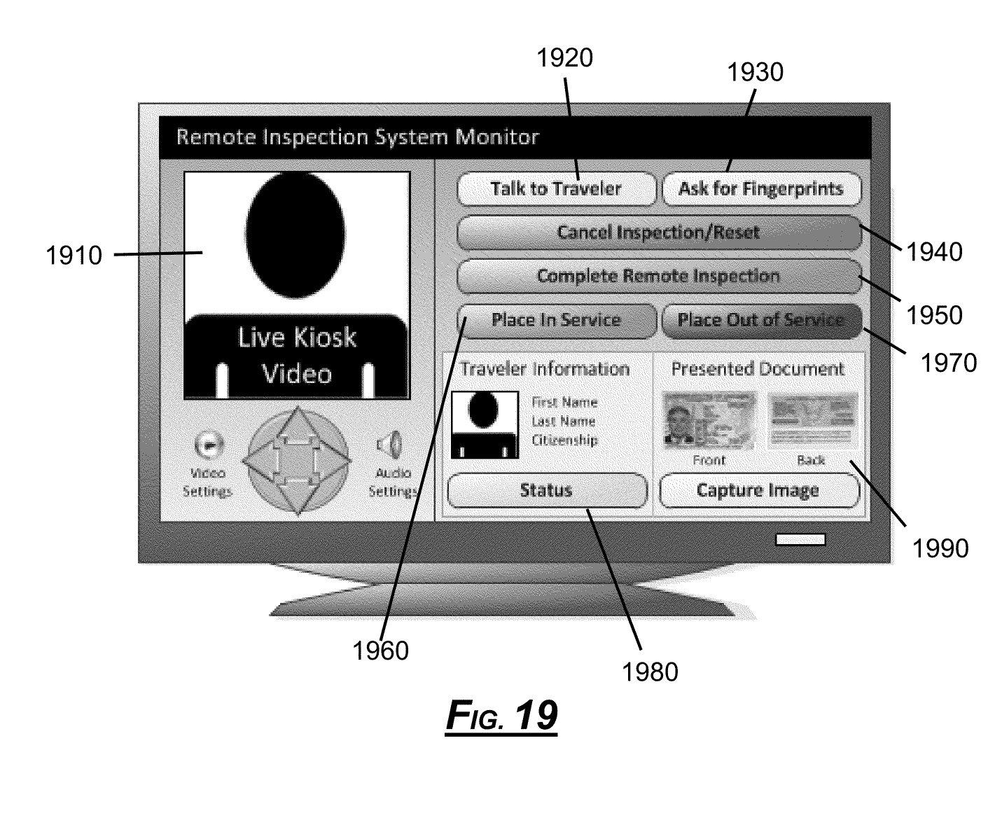

The officer display subsystem client application can initiate queries against law enforcement databases and display traveler photographs and crossing histories. It is also capable of verifying a traveler's identity through fingerprint capture (e.g., using the IDENT database). Referring to FIG. 19, a notional graphical user interface of an additional client application executed on a computer of an officer is shown. The graphical user interface of this client application is the RISM and allows the officer to remotely communicate with and authorize a traveler. The RISM has a video portion 1910 of the screen that allows an officer to see and hear a traveler at the remote kiosk. A plurality of buttons, which may be activated by a mouse, stylus, or by touch, include system commands such as “Talk to Traveler” 1920, “Ask for Fingerprints” 1930, “Cancel Inspection/Reset” 1940, “Complete Remote Inspection” 1950, “Place In Service” 1960, and “Place Out of Service” 1970. A status portion 1980 shows traveler information. A document portion 1990 shows a presented document and provides a button for a command to “Capture Image,” which stores an image of the presented document.

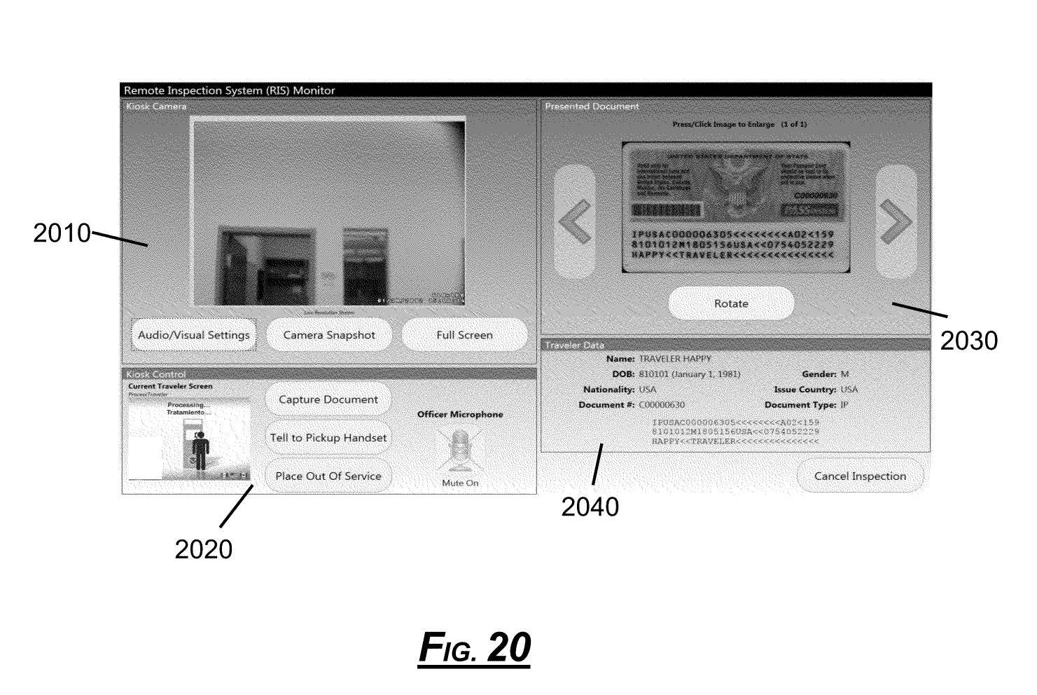

Referring to FIG. 20, a screenshot of a graphical user interface of RISM as displayed on a monitor is shown according to an alternative embodiment. A kiosk camera portion 2010 has a high/low resolution video stream and allows the officer to set audio and video controls (e.g., brightness), take a snapshot image, and view the video stream in full-screen mode. A kiosk control portion 2020 shows the current kiosk screen, sends kiosk commands (e.g., capture document, pickup handset, place in/out of service), and mutes officer audio. A presented document portion 2030 shows the document image(s), shows camera snapshot image(s), allows zoom-in on an image, and allows rotation of an image. A traveler data portion 2040 shows document data, shows raw MRZ data, and allows the officer to cancel inspection (i.e., clear screen).

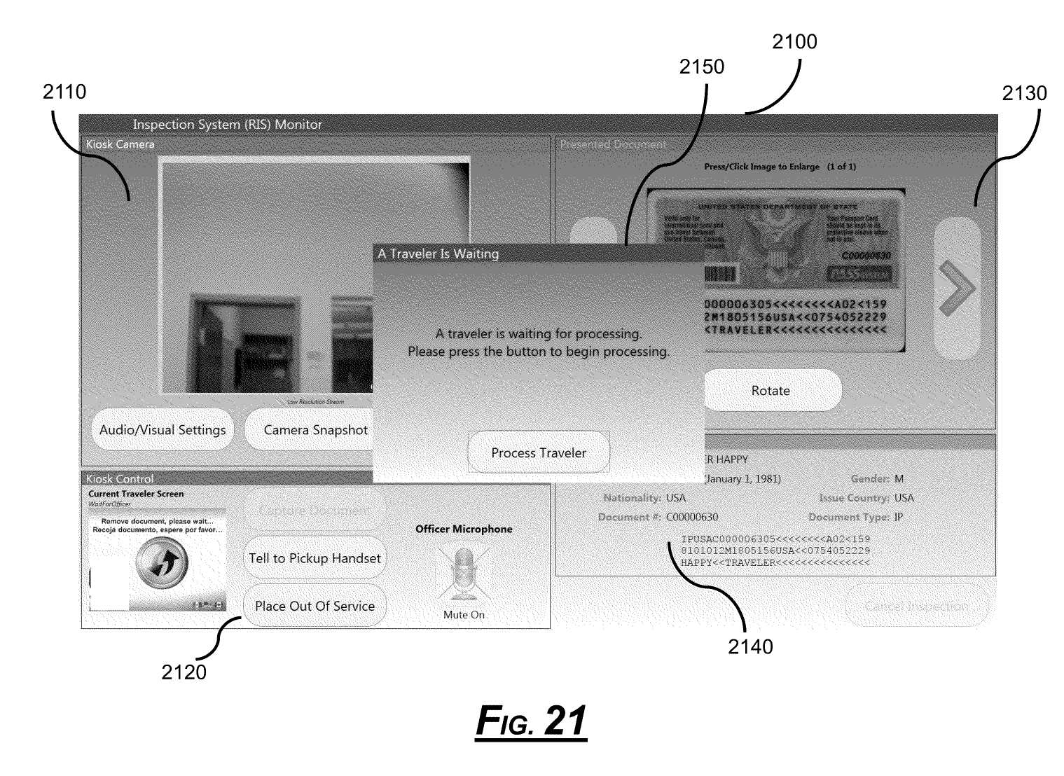

Referring to FIG. 21, a screenshot of a graphical user interface of a RISM as displayed on a monitor is shown. The RISM 2100 comprises a kiosk camera portion 2110, a kiosk control portion 2120, a presented document portion 2130, and a traveler data portion 2140. The kiosk camera portion 2110 has a high/low resolution video stream and allows the officer to set audio and video controls (e.g., brightness), take a snapshot image, and view the video stream in full-screen mode. The kiosk control portion 2120 shows the current kiosk screen, sends kiosk commands (e.g., capture document, pickup handset, place in/out of service), and mutes officer audio. The presented document portion 2130 shows the document image(s), shows camera snapshot image(s), allows zoom-in on an image, and allows rotation of an image. The traveler data portion 2140 shows document data, shows raw MRZ data, and allows the officer to cancel inspection (i.e., clear screen).

As shown in FIG. 21, a pop-up window 2150 is displayed on the RISM 2100 to indicate that a traveler is waiting for processing. In one embodiment, if the primary officer presses the button “Process Traveler”, information gathered based on presented documents from the traveler will be processed and displayed to the primary officer via the RISM and other client applications. In another embodiment, if the primary officer presses the button “Process Traveler”, the traveler will be informed to see a primary officer. In a one-to-one mode, the traveler will go to see the primary officer associated with the primary gate/kiosk where the traveler is waiting. In a many-to-many/on-deck mode, the traveler will go to see the primary officer from a specific indicator where the traveler is waiting. In the many-to-many/on-deck mode, the primary officer may determine whether to press the button “Process Traveler” after viewing the presented documents and other information related to the traveler on the RISM 2100.

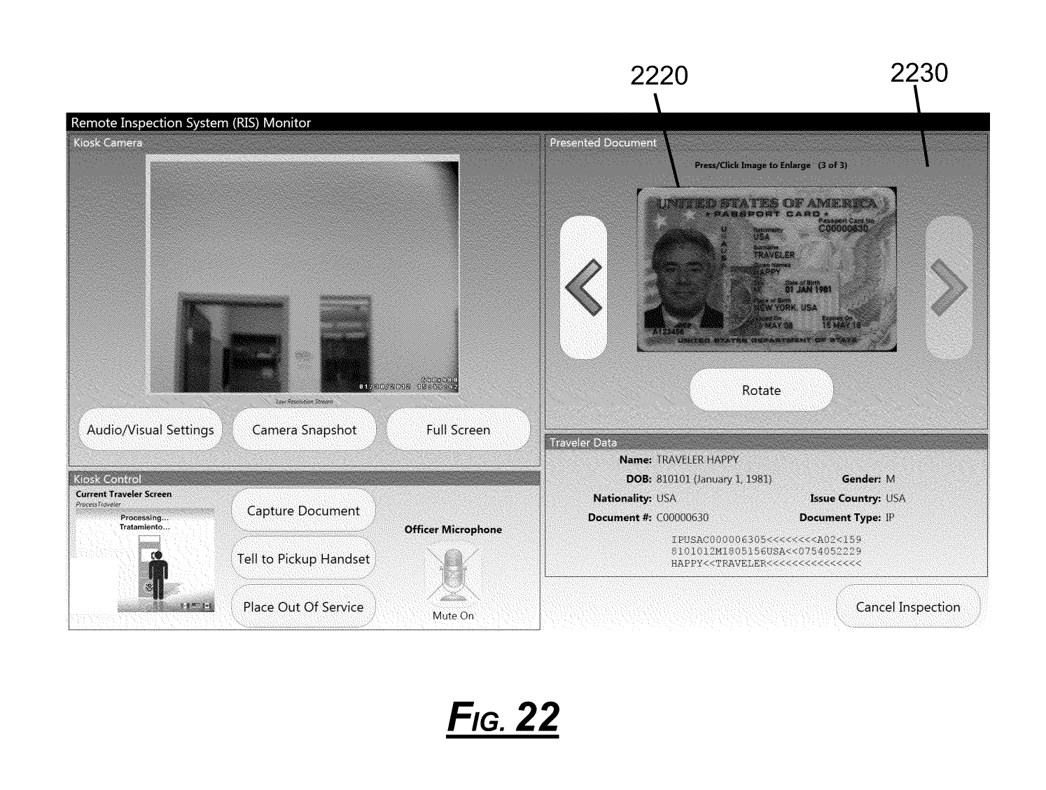

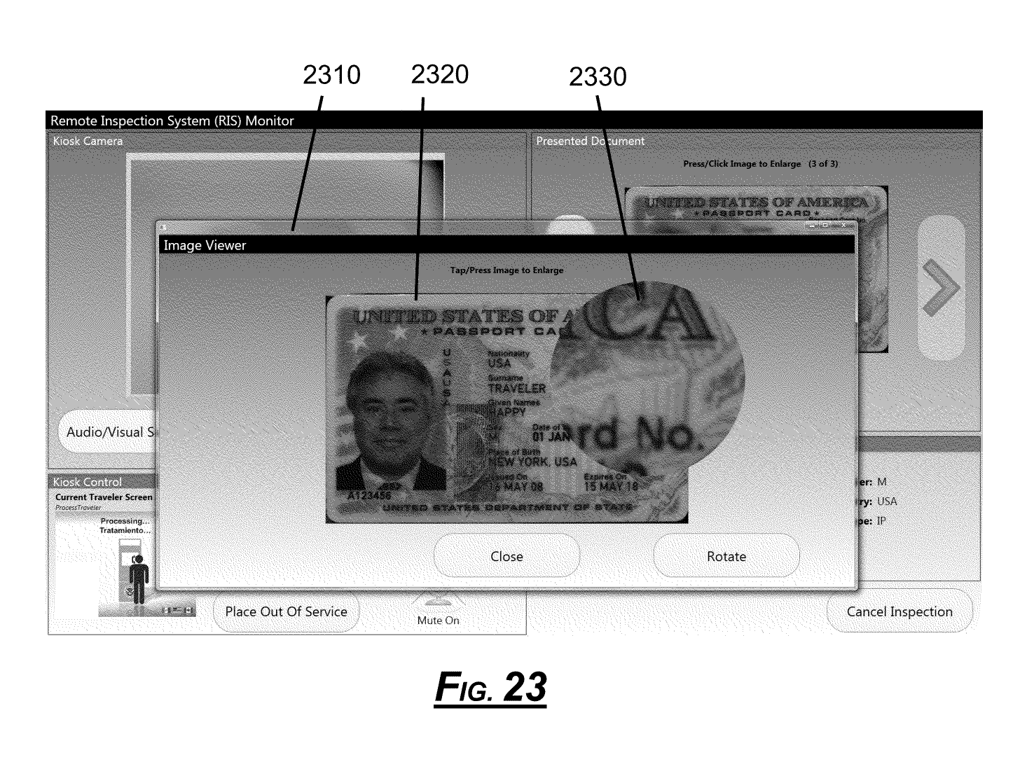

As shown in FIG. 22, a RISM is shown whereby a traveler has scanned a front image of a document 2220, which is displayed in the presented document portion 2230. As shown in FIG. 23, a pop-up window 2310 can be displayed that allows an officer to magnify 2330 or enlarge a portion or all of the presented document 2320.

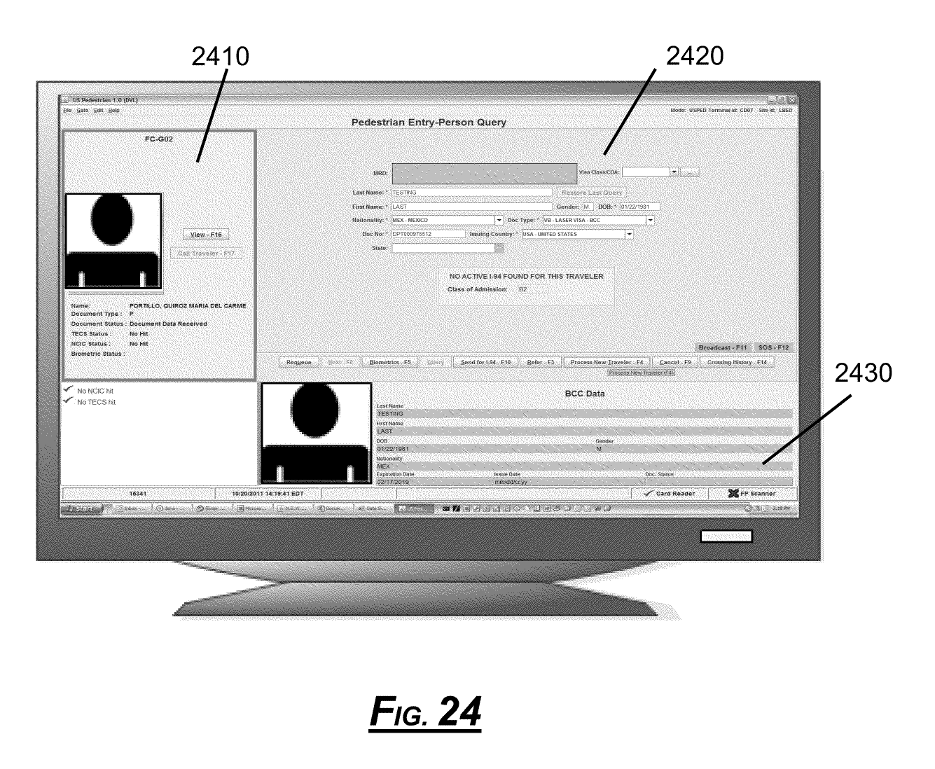

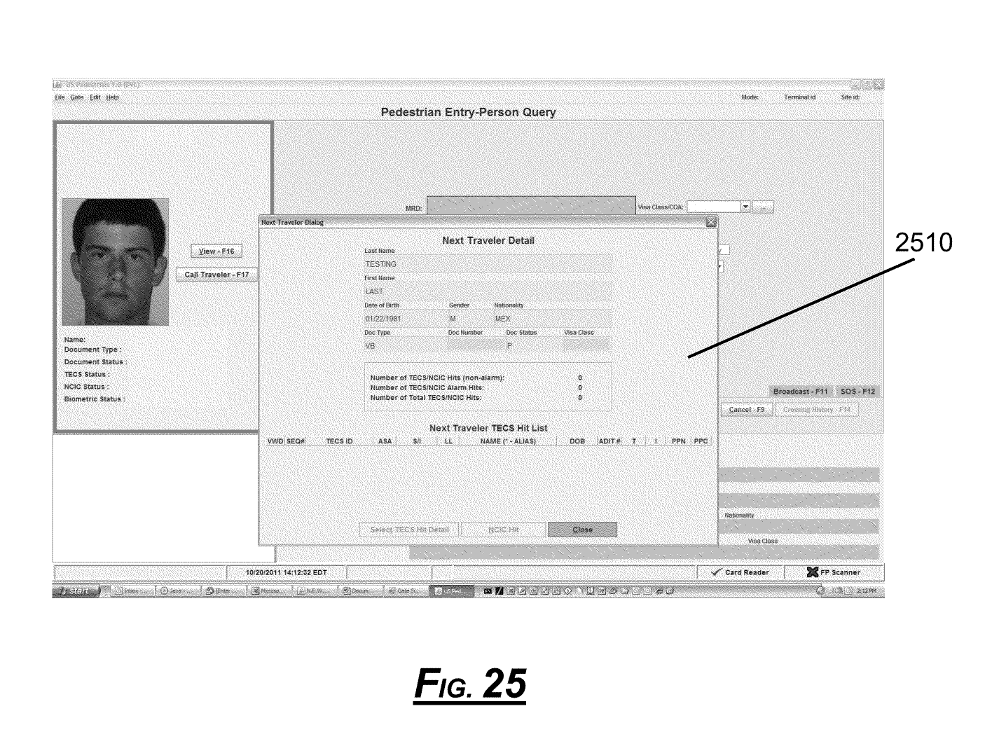

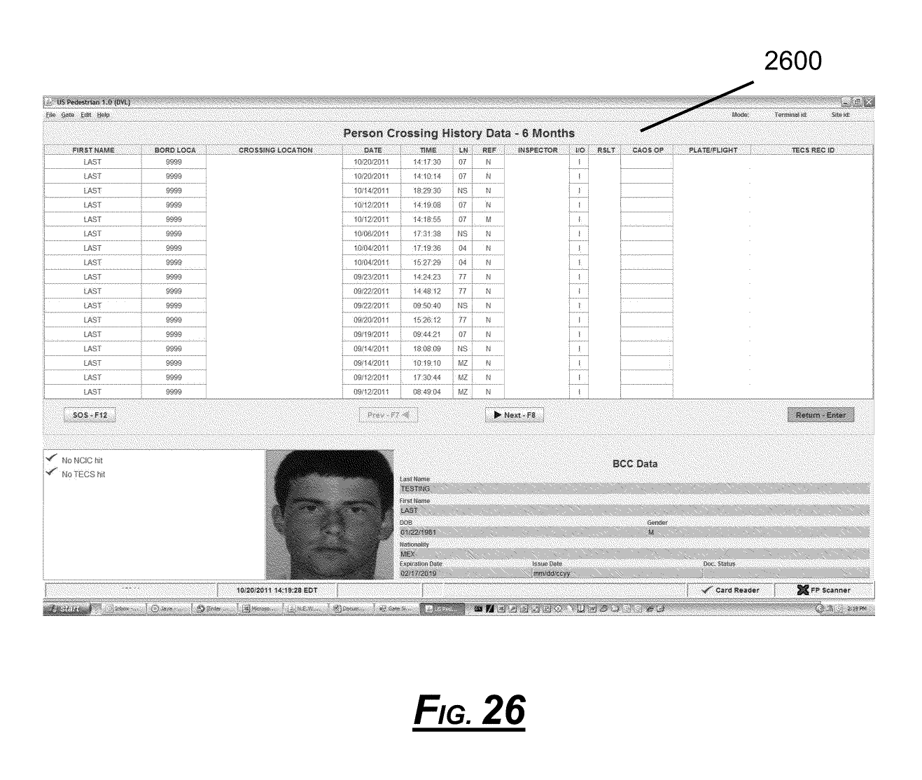

Referring to FIG. 24, a client application 2400 executed on a display of an officer's computer is shown. The client application provides to the officer all activity related information that is useful to render an admissibility decision. The client application 2400 has a gate view portion 2410 that allows an officer to see an image or video of a next available traveler at a gate/kiosk, a traveler query portion 2420 that allows the officer to enter information in various fields to conduct a search or other query, and a current traveler portion 2430 that allows the officer to see information about the traveler currently being processed at the booth. Referring to FIG. 25, a pop-up window 2510 can display information to the officer about a new traveler. Referring to FIG. 26, a client application 2600 can provide border crossing history data over a certain time period (e.g., unlimited, 6 months, one year) for a particular traveler.

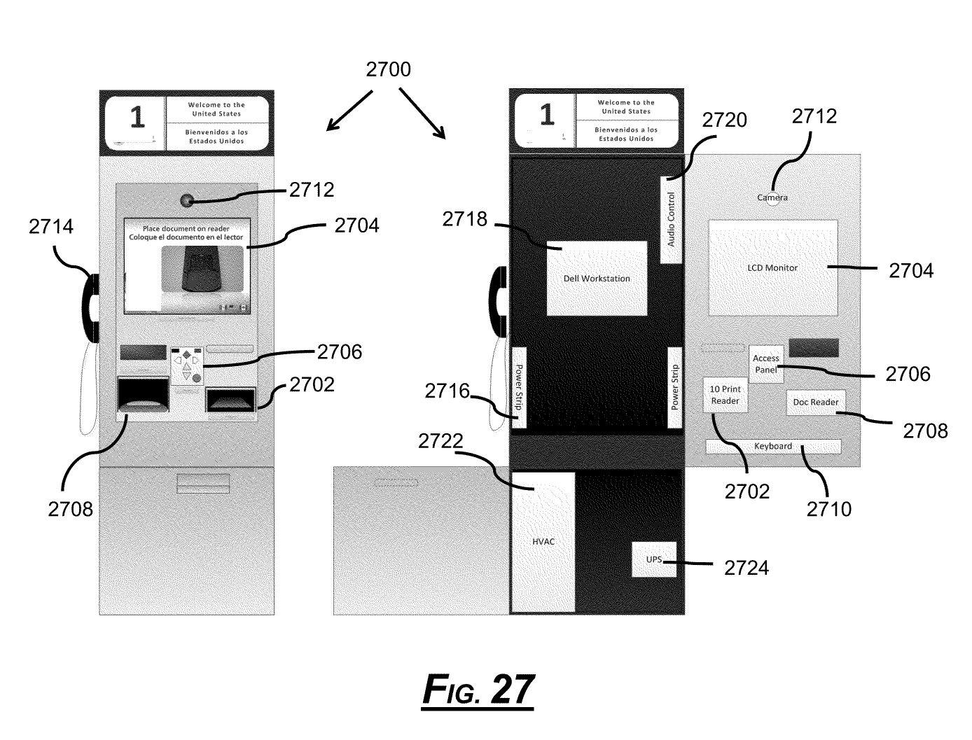

FIG. 27 illustrates a remote kiosk 2700 used for collecting biometric information according to an exemplary embodiment. In general, a kiosk used for collecting biometric information can be any type of electronic device that comprises a biometric detecting device. For example, the machine may be a laptop, personal computer, mobile phone, tablet, or personal digital assistant (PDA). The kiosk 2700 shown in FIG. 27 includes a fingerprint reader 2702, i.e., one type of biometric detecting device. FIG. 27 also illustrates a front view of the kiosk 2700 as well as a front view with access panels open to expose an inside structure of the kiosk 2700. As illustrated in FIG. 7, the kiosk 2700 includes an LCD monitor 2704, an access panel 2706 having buttons for entering commands, a document reader 2708, a keyboard 2710, a camera 2712, a telephone handset 714, at least one power strip 2716, a CPU 2718, an access control panel 2720, an HVAC 2722, and a UPS 2724.

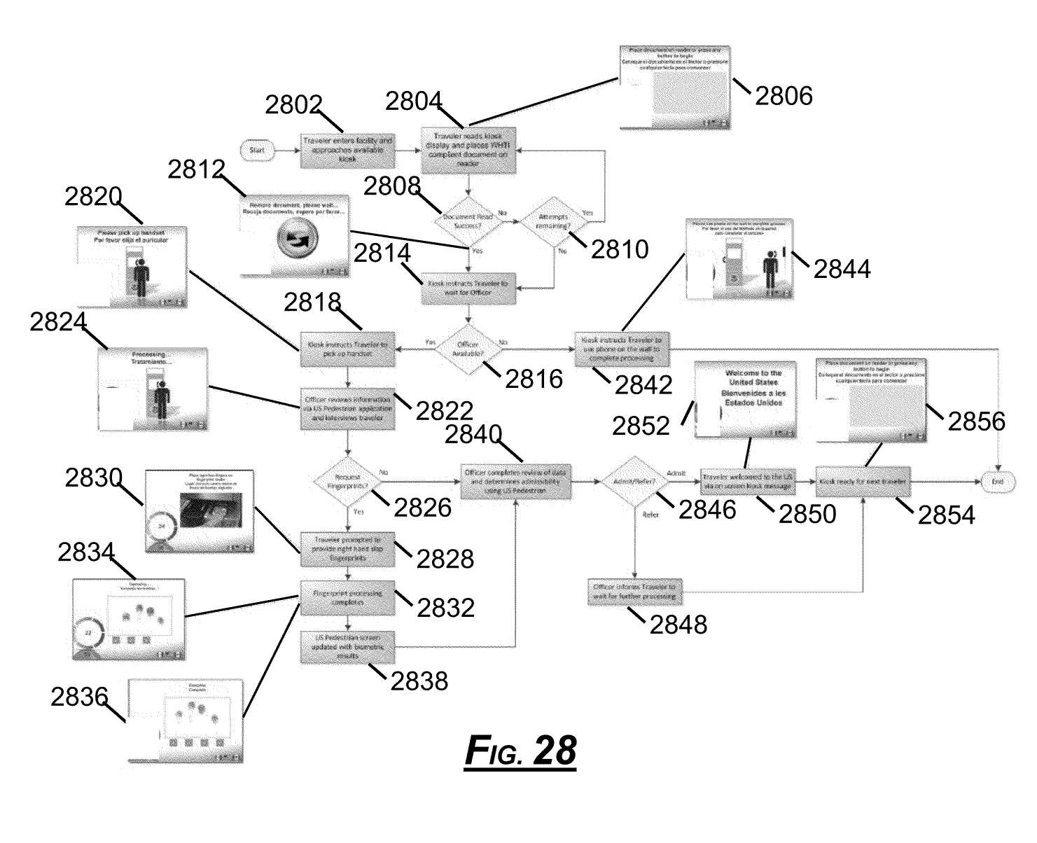

Referring to FIG. 28, an exemplary process is shown. In step 2802, a traveler enters a facility and approaches an available kiosk. In step 2804, the traveler reads the kiosk display and places a document (e.g., WHTI compliant document) on a document reader. A screen 2806 displays a message that says “Place document on reader or press any button to begin.” In step 2808, it is determined whether the document read was a success. If no, in step 2810, it is determined whether any attempts are remaining. If not, in step 2814, the kiosk instructs the traveler to wait for an officer. A screen 2812 says “Remove document, please wait.” In step 2816, it is determined whether an officer is available. If the officer is not available, then in step 2842, the kiosk instructs the traveler to use the phone on the wall to complete processing. A screen 2844 says “Please use phone on the wall to complete process.” If an officer is available, in step 2818, the kiosk instructs the traveler to pick up a handset. A screen 2824 says “Please pick up handset.” In step 2822, the officer receives information via the client application and interviews the traveler. A screen 2824 says “Processing.” In step 2826, it is determined whether to request fingerprints. If yes, then in step 2828, the traveler is prompted to provide a right hand slap of fingerprints. A screen 2830 says “Please place your fingers on fingerprint reader.” In step 2832, fingerprint processing completes. A screen 2834 says “Capturing” and shows the scanned fingerprints and validation of each finger. A screen 2825 says “Complete” and shows which fingerprints have been validated. In step 2838, a client application screen is updated with biometric results. In step 2840, the officer completes review of data and determines admissibility using the client application. In step 2846, it is determined whether to admit or refer the traveler. If refer, then in step 2848, the officer informs the traveler to wait for further processing. If admit, then in step 2850, the traveler is welcomed to the US via on-screen kiosk message. A screen 2852 says “Welcome to the United States.” In step 2854, the kiosk is ready for next traveler. A screen 2856 says “Place document on reader or press any button to begin.”

A mobile client application executing on a mobile device, such as a wireless handheld device can transmit to and receive messages from the backend processing subsystem by using a wireless network that is communicatively coupled to a wired network that is communicatively coupled to the backend processing subsystem.

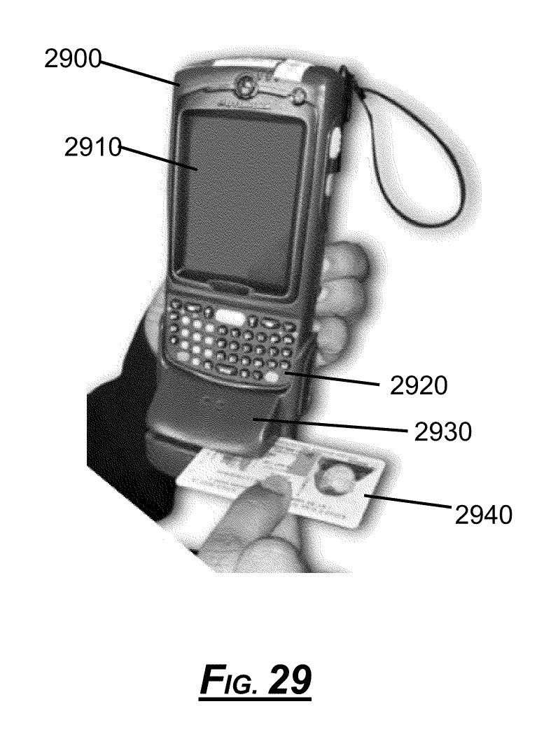

Referring to FIG. 29, an exemplary wireless handheld device 2900 is shown. The device has a touchscreen 2910 that may be activated with a finger or a stylus, a keypad 2920 for entering information, and a document reader 2930 for reading or scanning documents 2940. In this exemplary embodiment, the document reader 2930 is a MRZ document reader, but may also be an RFID reader or any other reader or scanner. The device 2900 can wirelessly communicate, e.g., using 802.11 and broadband networks.

A traveler's mobile device (e.g., mobile phone, cellular phone, personal data assistant, tablet computer, or other portable device that can connect to a network) can be used in addition to or in the place of the kiosks described herein. Using the mobile device can expedite traveler crossings, allow for a more personal interaction, and allow for dynamic and port/traveler-centric messaging. This type of system may be implemented at low-volume, remote ports of entry, as well as air and marine crossings, can introduce pre-primary gates without the associated hardware, can improve security by allowing an officer to conduct traveler queries before the expected traveler arrives, and can support community partnership and outreach by using directed messages or ads. The traveler can check-in using the mobile device application (“app”) in two locations: the port or proximity of the port (e.g., 1 mile, 5 miles) and at a booth. Using the functionality of the mobile device, the mobile device can be used for voice recognition of the traveler. The mobile device can also provide a live image of the traveler for verification with the scanned images. Other biometric information (e.g., fingerprints) may be obtained from the mobile device. The app may also require that the traveler check-in before a request expires in a pre-determined period of time (e.g., 30 minutes, 1 hour, 1 day). The port may send a message to the mobile device upon check-in that is based upon the nationality or document type of the traveler so that the traveler is compliant for a certain lane.

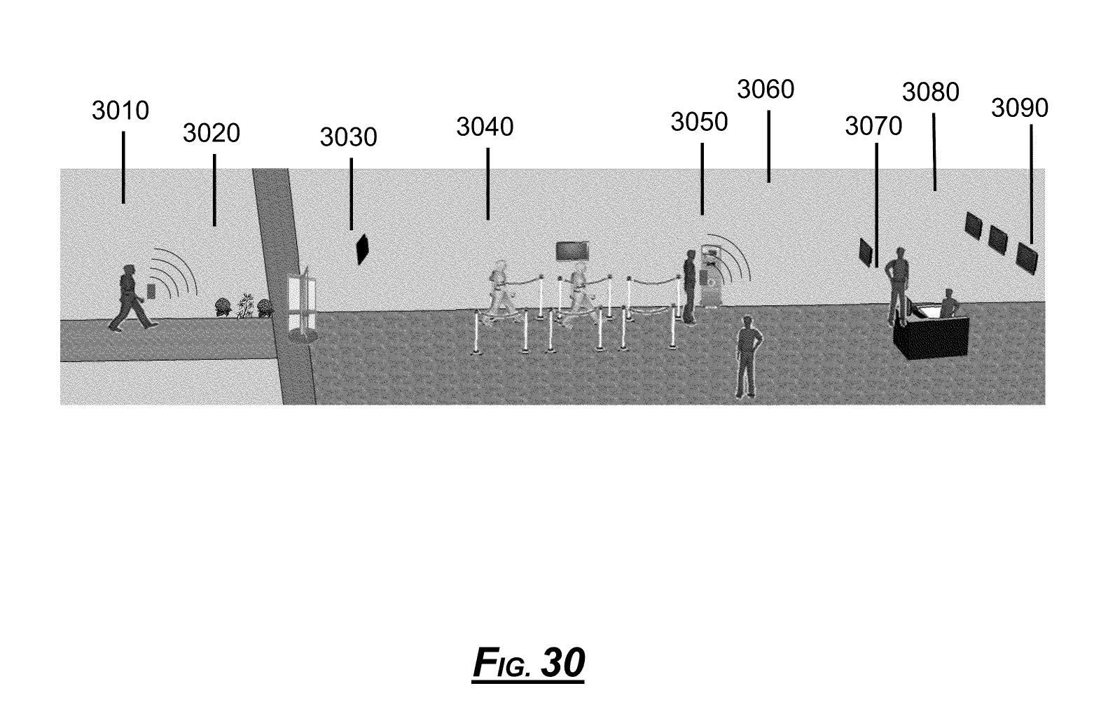

As shown in FIG. 30, an exemplary process for using a mobile device is shown. In step 3010, a traveler initiates a port check-in in a proximity of or in the port while using the mobile device and upon receiving a personalized message. In step 3020, the queries are initiated, and data is made available to a management console. In step 3030, the traveler enters the facility. In step 3040, the traveler proceeds through the queuing area. In step 3050, the traveler initiates booth check-in from the mobile device as directed. In step 3060, the officer directs the traveler to proceed for inspection. In step 3070, the traveler presents a document to the officer as directed. In step 3080, the officer finalizes processing. In step 3090, the traveler is admitted or referred and enters a post-primary zone.

A traveler can register on a mobile device. The traveler can self-register by capturing a facial photograph, a travel document photograph, and a MRZ document. The MRZ can be parsed and displayed. The registration information can be transmitted to a server and associated with a record of an existing traveler. A unique traveler ID is then returned to the mobile device. The background color of the mobile device can be associated with a status (e.g., nationality) of the traveler. For example, a blue background signifies a U.S. citizen and a yellow background signifies a non-U.S. citizen.

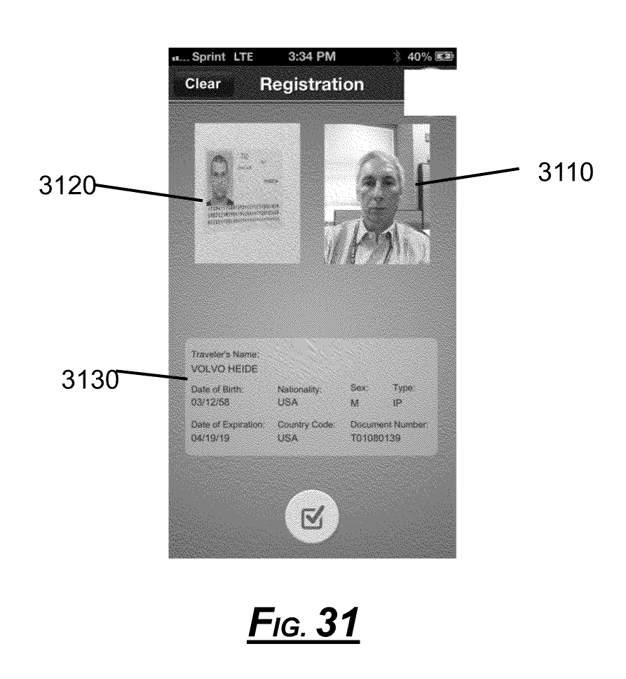

Referring to FIG. 31, a registration screen of a graphical user interface displayed on a mobile device of a traveler is shown. The registration screen has a photograph 3110 of the traveler, a travel document photograph 3120, and biographical information 3130 about the traveler that can be manually entered by the traveler and/or obtained from MRZ information.

After registration, the traveler can check-in using the mobile device. The traveler must be present on the grounds of the port or in a proximity to the port. Location-based services mapping on the mobile device can allow the system to determine the location of the traveler. The traveler will not be able to check-in without being in the proximity of the port. Upon checking-in, queries about the traveler will be initiated and a QR code (or other scannable bar code, image, or alphanumeric characters) is generated for the traveler containing a transaction ID.

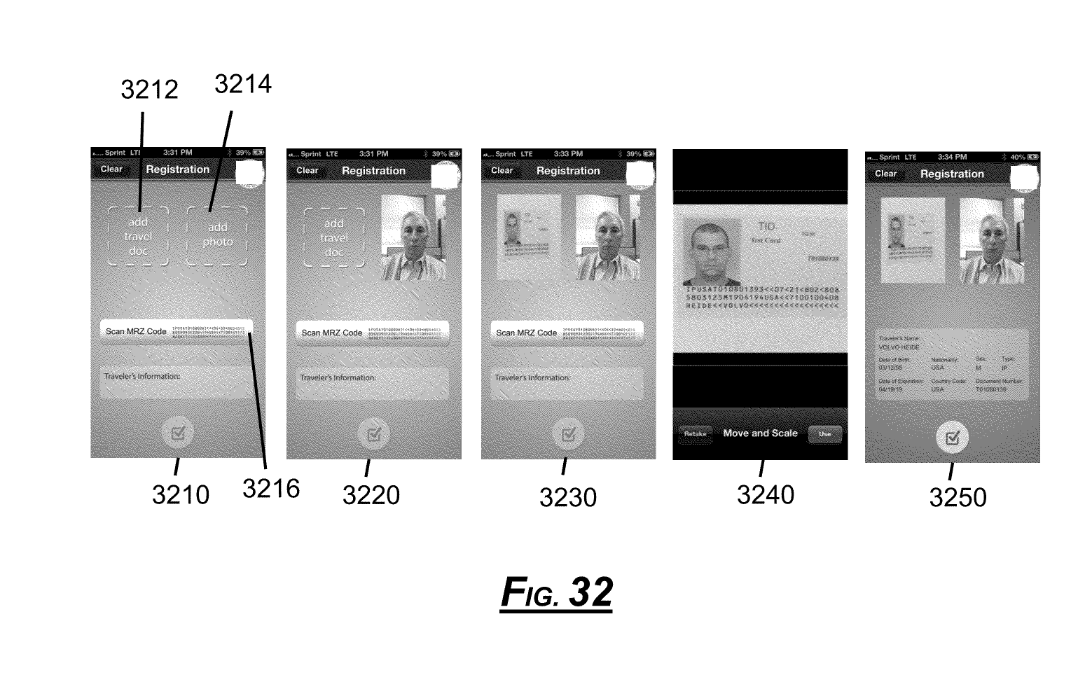

Referring to FIG. 32, an exemplary registration process is shown. In screen 3210, a first display is shown on the traveler's mobile device. The traveler can select to add a travel document 3212, add a photo 3214, and scan/parse MRZ 3216. The background may be a first color, such a green, to signify an unregistered traveler. The first color is different than the color of a background for a U.S. citizen or a non-U.S. citizen. In screen 3220, the traveler can capture a photo using a camera on the mobile device. In screen 3230, the traveler can capture a document using the camera on the mobile device. In screen 3240, the traveler can adjust, move, and scale the captured document, which includes a MRZ. In screen 3250, the document is parsed to generate information about the traveler, and the registration is completed. The background can turn to a second color that signifies the citizenship of the traveler. The screen 3250 confirms that check-in is enabled.

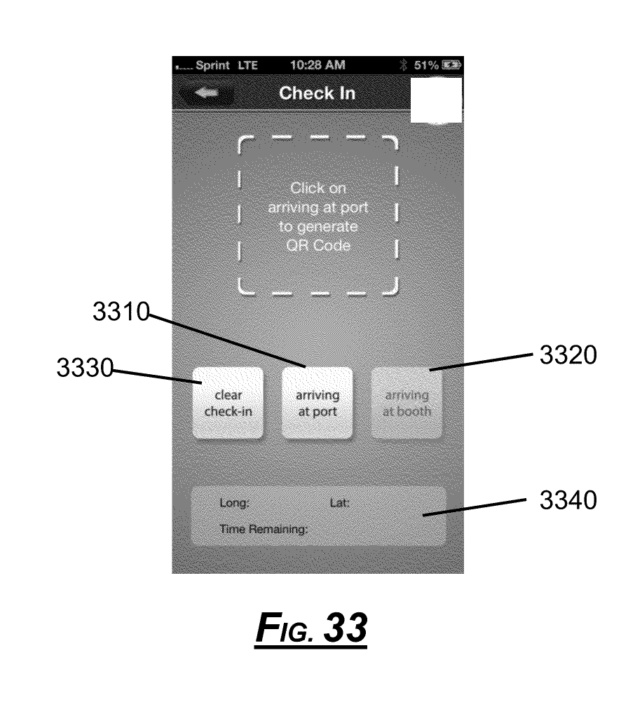

Referring to FIG. 33, a check-in screen of a graphical user interface displayed on a mobile device of a traveler is shown. A traveler can click on a button 3310 for “arriving at port” when the traveler is in the vicinity of the port. Alternatively, the traveler can click on a button 3320 for arriving at booth when checking-in on the port premises. A button 3330 allows the traveler to clear a check-in request. A location portion 3340 displays a longitude and latitude of the traveler along with a time remaining for the traveler to check-in. The longitude and latitude information can be obtained from location-based services or global positioning satellite services of the mobile device.

The traveler can check-in using the mobile device next to the booth at the port of entry. As a result, the traveler can be correctly sequenced within the client application display for the officer. The traveler can initiate booth check-in by calling a service or by presenting a QR code, which was generated by the port check-in. A QR code can be posted in the lane near the booth that can be read by the mobile device so that the lane of the traveler can be determined for booth sequencing. Having a static QR code posted in the lane near the booth reduces the amount of equipment deployed to the field as well as associated operations and maintenance of the equipment. A bar code reader can be integrated at the booth so that the traveler does not need to initiate the booth check-in. The system will initiate the check-in upon reading the QR code. After check-in is complete, local businesses can send messages to the traveler.

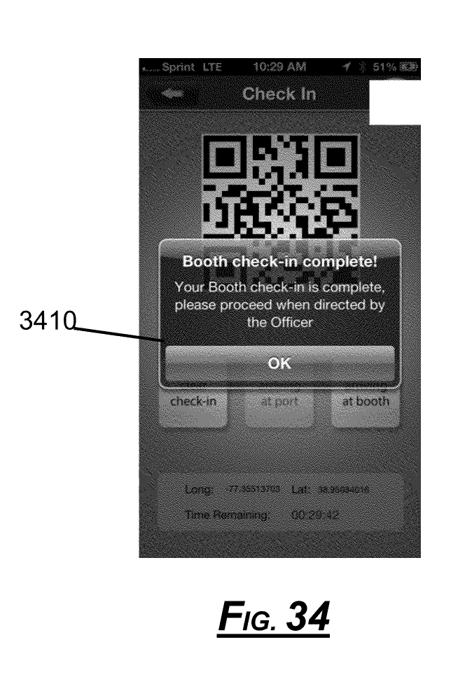

Referring to FIG. 34, a check-in confirmation screen of a graphical user interface displayed on a mobile device of a traveler is shown. This screen has a pop-up window 3410 that is displayed upon a successful check-in. In this example, the traveler completed a successful booth check-in, but a port check-in may show a similar screen. The pop-up window 3410 states that “Your booth check-in is complete, please proceed when directed by the Officer.”

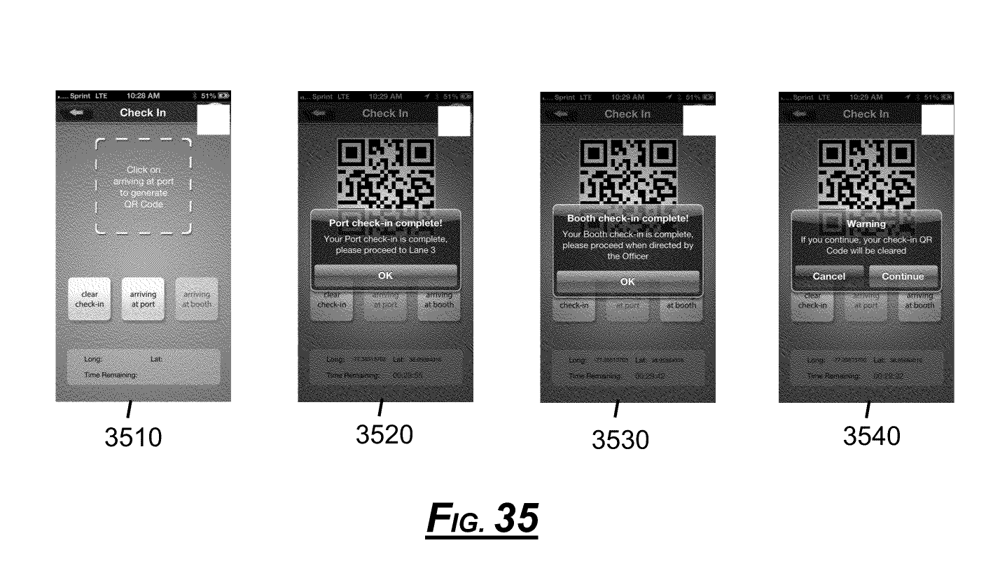

Referring to FIG. 35, an exemplary check-in process is shown. Screen 3510, as shown in FIG. 33, is an initial check-in display. Screen 3520 shows that the port check-in is complete. A QR code 3522 is generated for the traveler on the screen, longitude and latitude become visible on the screen, and a check-in countdown begins. A pop-up window states that “Your Port check-in is complete, please proceed to Lane 3.” Screen 3530, as shown in FIG. 34, shows that booth check-in is complete. Screen 3540 shows that a traveler can clear the check-in process from the mobile device. A pop-up window states that “If you continue, your check-in QR code will be cleared.”

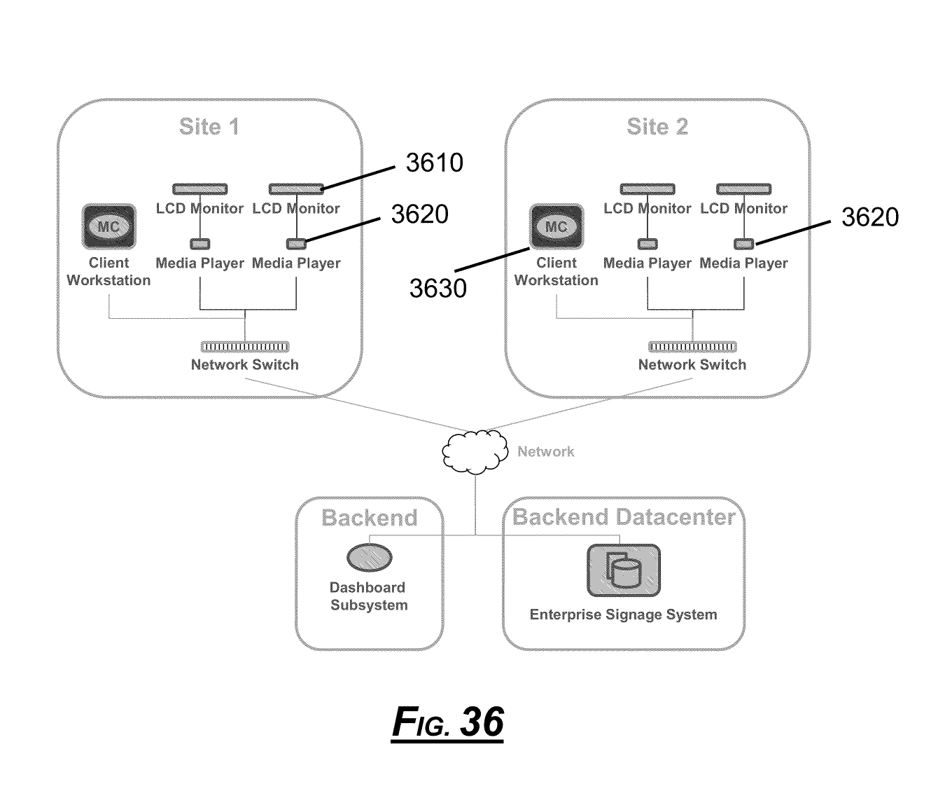

Digital signage can be installed to help direct and inform the traveler as they approach and progress through the facility. The system integrates with this site signage system and provides the framework for dynamic sign content, based on tactical operations. As shown in FIG. 36, a system overview of the signage control subsystem is shown. A watch command workstation 3630 has an officer display subsystem Management Console (MC). The MC allows supervisors the ability to quickly change the content displayed on one or more LCD or LED monitors 3610. A map based layout customized for each facility provides spatial layout of all signs and displays current operating parameters and status for each sign. Numerous LCD and LED signs are deployed throughout a facility and connect to the network via media player computers 3620. An enterprise signage system is located in the backend subsystem and includes media files, media loops, configuration information, and stored signage settings known as signage templates. Templates allow a site to quickly switch signs to a predetermined mode of operation at particular points in the day. A pre-primary LCD provides informational and directional content for travelers as they approach the pre-primary gate systems. A primary LCD provides informational and directional content for the travelers as they wait in the queuing area just before the primary gates, and it may display instructions on how to use the fingerprint device. Booth LCDs provide informational content to the traveler at the primary gate/kiosk and booth. Associated signage is placed overhead directly above each primary processing booth. A single board computer (SBU) or standard small form factor computer can serve as the media player serving each LCD sign.

Referring again to FIG. 1, the signage control subsystem 120 interfaces with facility site and lane signage deployed at the site to provide general information for travelers in the use of the gate systems and other relevant information on the overall traveler process. The signage control subsystem 120 provides a published interface for external control of selected signage operations. To support remote operational and maintenance activities, the signage control subsystem collects and reports configuration, heartbeat, fault, and notification data to the dashboard subsystem 150 for all component pieces.

The signage control subsystem sends messages to the backend processing subsystem and the dashboard subsystem. The signage control subsystem sends initialization messages to the backend processing subsystem that include identification data, current operation mode, and session information used by external components to communicate with the signage control subsystem. The signage control subsystem sends faults, heartbeats, and notifications to the backend processing subsystem to provide operational status of equipment. The signage control subsystem sends configuration and health data to the dashboard subsystem to remotely manage hardware and software configurations and to convey health statistics (e.g., memory use).

The signage control subsystem 120 has a media player computer 121 that includes a network interface. A middleware component in the media player 121 provides an interface with site and lane signage. The media player 121 can also periodically collect configuration and health information and transmit to the dashboard subsystem 150 to support configuration and operational management. The signage control subsystem 120 also has signage 122, which includes a site media server, LCD displays, and controllers.

The signage control subsystem can be configured to dynamically change a message, image, video, or audio on one or more displays. In one embodiment, as officers log into and out of the officer display subsystem, the signage control subsystem can adjust the signage to show which lanes or booths are available or are no longer available. In another embodiment, the signage can change based upon traveler traffic. For example, if the traffic is below a certain threshold, the signage can change to direct the travelers to fewer lanes, or the signage can change to allow for different types of processing at different lanes. During heavy traffic flows (e.g., rush hour), it may be helpful to have a lane only for those travelers with RFID documents to allow expedited processing of those travelers. During slower times, the signage may dynamically adjust so that there are no restrictions on the lanes, i.e., allow processing of RFID documents, MRZ documents, and/or those with insufficient documents or no documents. The backend processing subsystem can determine the volume of traffic and provide instructions to the signage control subsystem to adjust accordingly. The backend processing subsystem may also recognize patterns in the traffic and provide instructions to the signage control subsystem. When adjusting the signage directing travelers based upon an amount of traffic flow, the signage can automatically adjust to a new signage when the traffic flow reduces. The amount of traffic can be determined by using a crowd monitoring sensor, which sends a signal to the backend processing subsystem. The backend processing subsystem can send instructions with a signage routine or may provide traffic volume information to the signage control subsystem, which then selects a signage routine. In another embodiment, as described above, the signage can also change dynamically based upon the processing of travelers at a pre-primary gate to display an indicator for a primary gate or a booth to call upon the next traveler associated with that indicator. In another embodiment, the signage may be automatically adjusted to account for a group of individuals to be processed together, such as an arrival of a bus at a security checkpoint facility.

The officer display subsystem 130 has a variety of display devices and applications that provide officers with the capability to collect traveler data (document and/or biometric), initiate traveler queries, display law enforcement results, and monitor and control remote kiosks. These display devices are a fixed workstation located at an Officer's booth, a mobile handheld platform used by roving officers, a management console application that provides the capability to configure the gate/kiosk subsystem 110 and monitor travelers as they proceed through the system, and a remote inspection station monitor application that only monitors/controls remote kiosks.

The officer display subsystem sends messages to the backend processing subsystem, signage control subsystem, and gate/kiosk subsystem. The officer display subsystem sends authentication requests to the backend processing subsystem to authenticate an officer onto the wireless network or officer display subsystem applications. The officer display subsystem sends person and document queries using collected traveler data (e.g., MRZ, RFID, manual entry) to the backend processing subsystem. The officer display subsystem sends fingerprint queries initiated using collected traveler fingerprints to the backend processing subsystem. The officer display subsystem sends signal control commands to the signage control subsystem to change site and lane signage. The backend processing subsystem sends commands to control gate operations (e.g., open/close gate, set gate/kiosk subsystem mode) to the gate/kiosk subsystem. The officer display subsystem sends audio to the remote kiosk of the gate/kiosk subsystem.

The officer display subsystem 130 has a client application 131 for use at an officer booth. The application 131 includes the ability to pre-read and have advance traveler information, ability to query and view the crossing history for the traveler, ability to package travelers by family, group, or mode of transportation (e.g., bus, taxi, boat), fingerprint verification, and enrollment. The client application 131 provides the ability to display next available traveler information and hits. The client application 131 connects with application and integration services and receives person query results created/initiated as a result of any gate/kiosk subsystem queries. It presents this information to an officer who may decide to admit, refer to an secondary officer, or cancel the traveler query transaction. In addition, the client application allows an officer to perform traveler queries using biographical data that he or she manually enters or obtains from a document reader (such as MRZ). The client application 131 also receives and displays results for direct client queries on hit details and crossing history. Complex hits are also presented and processed as a result of person queries. The client interfaces to command gate/kiosk open upon officer initiating the call (next) traveler.

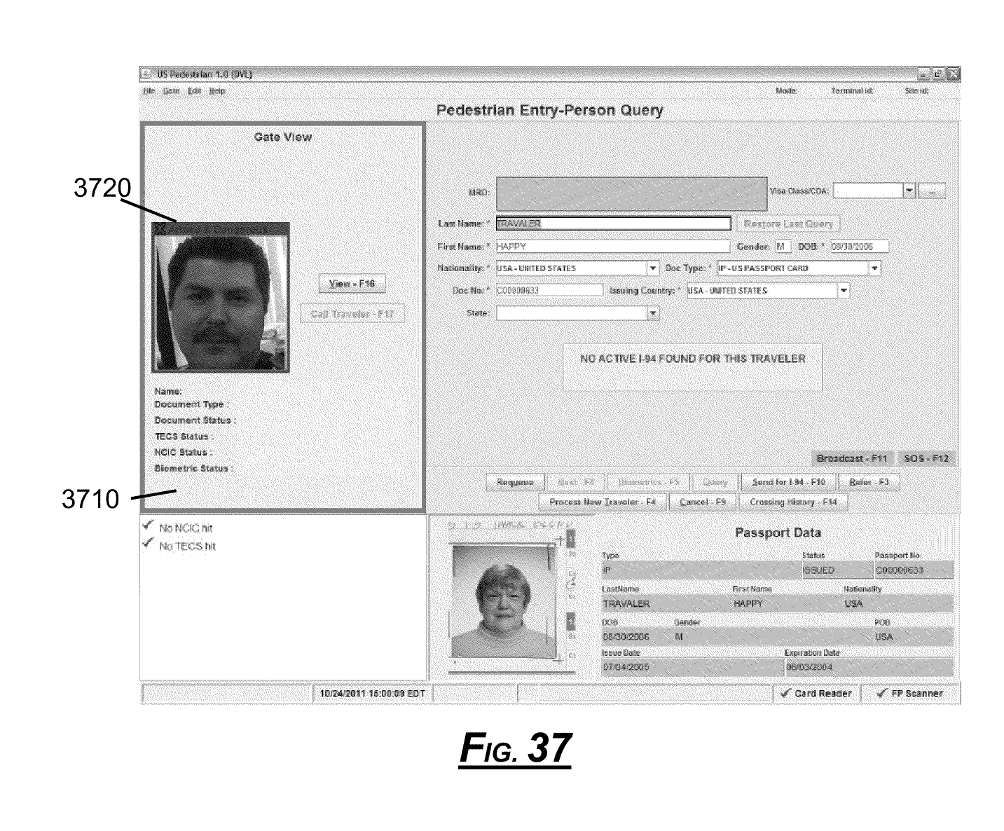

Referring to FIG. 37, a screenshot of a client application on a graphical user interface displayed on a monitor of a workstation for an officer is shown. The client application has summary information 3710 about the next traveler before the next traveler physically arrives at the officer's booth. Adverse information on the next traveler may be made noticeable using different colors or indications, such as a red border 3720 contrasting with the remainder of the graphical user interface and stating “Armed & Dangerous.” At the officer's discretion, the next traveler's detail information can be viewed before they pass through the primary gate and approach the officer's booth.

A mobile client application 132 can be used on a wireless handheld device (as shown in FIG. 29) to provide a tool to conduct traveler manual and document queries as well as monitor travelers proceeding through the gate/kiosk subsystem. The mobile client application 132 provides traveler information to officers using display devices with limited screen real-estate while they are roving pedestrian zones and/or processing travelers. Officers log into the management console 133 and select gates (preprimary and/or primary) from which the officers wish to receive traveler information. Officers can use the management console 133 to initiate queries to backend systems and to review traveler information. In addition, the management console 133 will support entry of traveler data (with the help of document readers) and initiate queries based on such data.

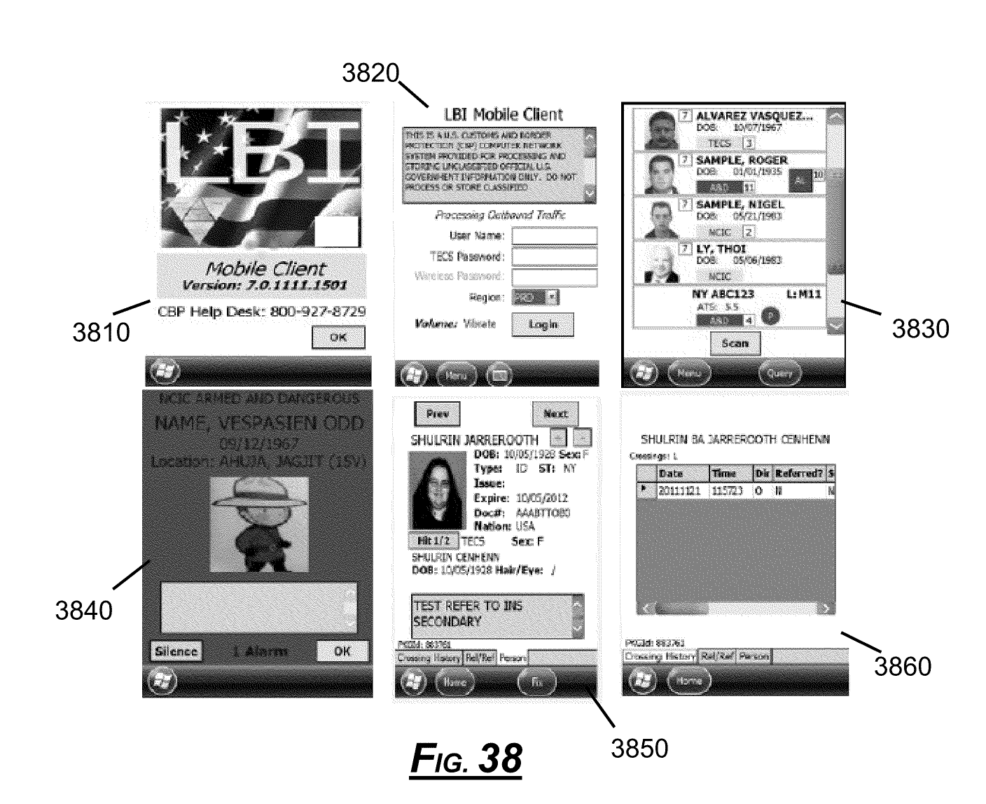

Referring to FIG. 38, exemplary screenshots are shown for a mobile client application as displayed as a graphical user interface on a mobile device, such as a wireless handheld computer. Screenshot 3810 illustrates a welcome screen. Screenshot 3820 illustrates a login screen for an officer. Screenshot 3830 illustrates a listing of travelers that have passed through a pre-primary gate. Screenshot 3840 illustrates a warning that a traveler is armed and dangerous. Screenshot 3850 illustrates a traveler with biographical information and a message to refer to a secondary officer. Screenshot 3860 illustrates a listing of crossings for a particular traveler.

The management console 133 allows configuration of the gate/kiosk subsystem 110 and signage subsystem 120, as well as provide monitoring of travelers as they proceed through gate/kiosk systems.

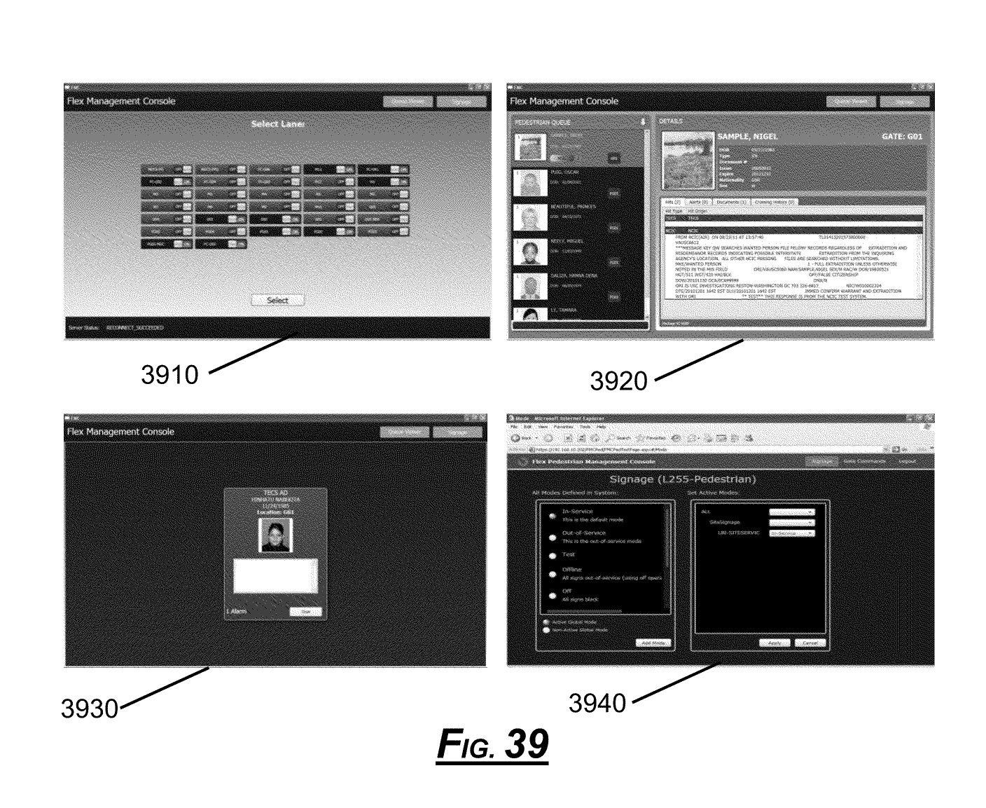

Referring to FIG. 39, a management console allows an officer to view traveler information and alarms. The officer can select pre-primary and primary gates to monitor, view traveler summary information and/or traveler details, and display alarms received at gates and/or other wireless handheld computers. The officer can also control digital signage by designating in service or out of service, and control operational loops. The officer can control gates by designating in service or out of service and opening and closing the gates. A graphical user interface 3910 shows how an officer can select a lane, display, or other component to designate in service or out of service. A graphical user interface 3920 shows a pedestrian queue and details of a selected pedestrian traveler. A graphical user interface 3930 shows information about a traveler. A graphical user interface 3940 shows a control panel for monitoring and changing signage.

A remote inspection station monitor (RISM) 134 is an application to control remote kiosks, obtain kiosk status and document images, and interface with video camera and audio system. The RISM 134 application may be executed on a workstation. The RISM 134 has the capability to monitor the kiosk video camera, conduct two-way audio communications with the traveler at the remote kiosks, and view document images read by the remote kiosk document reader.

The backend processing subsystem 140 comprises services and law enforcement systems that route messages initiated from site components, conduct a variety of traveler-based queries, store traveler data and results for later access and reporting, and deliver query results to Officer workstations and mobile devices at the site. It is responsible for receiving traveler data from unattended (e.g., gates) and attended (e.g., officer workstations and mobile) devices, orchestrating queries to multiple law enforcement systems, compiling the results, and forwarding the results to user devices in the officer display subsystem 130. All traveler-based data and results are retained for access through a web reporting tool to support analysis and/or investigations.

Referring again to FIG. 1, the backend processing subsystem sends messages to the dashboard subsystem, signage control subsystem, gate/kiosk subsystem, and officer display subsystem. The backend processing subsystem sends faults, notifications, and heartbeats from the gate/kiosk subsystem and signage control subsystem to the dashboard subsystem to provide operational status of equipment. The backend processing subsystem sends signal control commands to the signage control subsystem to change site and lane signage. The backend processing subsystem sends commands to control gate operations (e.g., open/close gate, set gate/kiosk subsystem mode) to the gate/kiosk subsystem. The backend processing subsystem sends fingerprint processing commands to the gate/kiosk subsystem to inform the gate whether to capture fingerprint biometrics for the current traveler. The backend processing subsystem sends success or failure of authentication request and user information to the officer display subsystem. The backend processing subsystem sends results of person/document queries that include traveler data, hits, and/or alarms to the officer display subsystem. The backend processing subsystem sends results of fingerprint queries to the officer display subsystem confirming the identification of the traveler. The backend processing subsystem sends results of person queries (e.g., traveler data, hits, alarms) to display devices of the officer display subsystem that did not initiate the queries but are subscribed to receive data and alerts.

The backend processing subsystem 140 has backend services to route messages from site components to backend components. The backend services can provide traveler queries services, interface with mainframe services, manages officer display subsystem 130 components and mobile services, and interface with a management services and the gate/kiosk system 111. The backend services receive document queries, but does not respond with results and instead can collect the results and cache them (along with fingerprint capture data) for presentation at a primary workstation. A mobile services component can provide mobile equipment support that includes queries from mobile devices, managing mobile device notifications, and translating mobile transaction messages. The backend services can also route requests to external service providers and collect the returned results. The backend services has a core that provides primary query orchestration, alarming service, caching services, subscription services, alert broadcast services, device management services, and metrics services. The core orchestrates traveler and travel document query information by initiating requests based upon input received from a gate, a mobile device, or from a workstation; routing requests to service providers; receiving service provider results; presenting service provider results; and opening and closing gates. The backend services have a management component that can manage connections and interfaces with the clients, site configuration management, and alert broadcast service management. A traveler activity monitor provides support for metrics analytics, reporting, system performance metrics, etc. A communication component supports activity monitor assessments, provides real time monitoring support for lane status and history, real-time results and hits of gate queries, and support for site and alarming configurations. A border transition history service provides an interface with the mainframe for crossing history services. A document and individual query service provides an interface with the mainframe for person and document query services. A biometric service provides an interface for biometric authentication and watch list alerts.

The dashboard subsystem 150 receives configuration, heartbeat, fault, and notification data from gate/kiosk subsystem 110 and signage control subsystem 120 that allow remote operations and maintenance of these system components. It can receive and analyze fault data to provide a real-time operational view of subsystem status and assist in the diagnosis and resolution of subsystem faults. The dashboard subsystem 150 receives configuration, health, heartbeat, fault, and notification messages from the gate/kiosk subsystem 110 and signage subsystem 120 to support remote operation and maintenance activities for these components. The dashboard subsystem 150 graphically represents the status of the subsystem for an operations and maintenance team. The graphical user interface can proactively monitor all areas, alert an engine to apply business rules to data feeds and raise actionable alerts, and retain historical data to support drilldowns, fault analysis, and trends. The operations and maintenance team can use this visual display to monitor subsystem status and to troubleshoot any issues that may arise.

The system collects accurate, valid, and time-stamped data throughout the process to allow the system to report on the entire traveler encounter. In a pre-primary zone, as shown in FIG. 2, the system may collect data including: type of travel document presented, citizenship of traveler, number of attempts to read document, number of failures for document capture, number of non-compliant documents, number of travelers processed, time to capture presented document, time from initial interaction with the system until complete passage through gate assembly, time for query to complete, time from when processing complete until gate opens, time from gate open to gate close, time to capture fingerprints, number of successful fingerprint processes, number of failed fingerprint processes, time to complete fingerprint verification, and quality of fingerprint samples. In a primary zone, the system may collect data including: existing application data capture and metrics, and additional data that may be captured to identify particular points of the process where information collected earlier was viewed, system buttons were pressed for traveler approach, etc. In a client zone, the system may collect data including: time for viewing next traveler details, time for closing the next traveler view, time for calling/making a next traveler become the current traveler, time for resetting the gate, time for closing the gate, and time for re-queuing the current traveler back to the next traveler queue. In a backend zone, the system may collect data including time of traveler disposition.

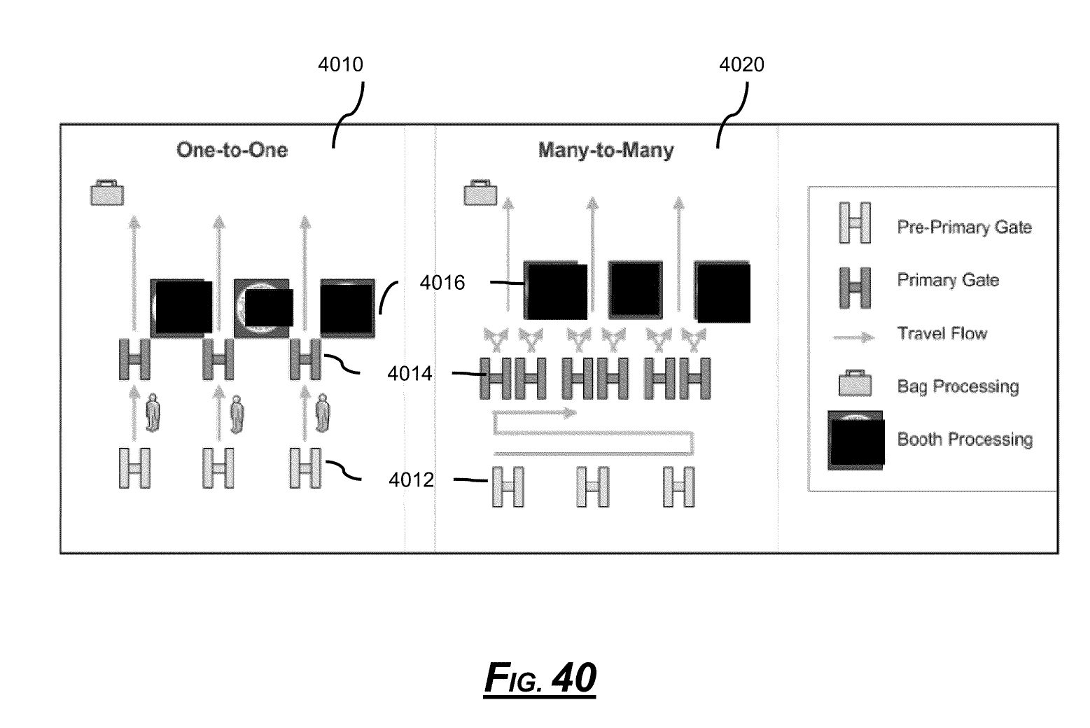

While there are a plurality of travelers entering the facility in a same time period, a scheme or mode is needed to organize them through the system. FIG. 40 illustrates two configurations corresponding to two modes of organizing traveling users according to an exemplary embodiment.

The one-to-one mode shown in 4010 can be used when there is one, and only one, primary gate/kiosk 4014 associated with a primary booth 4016. In this mode, the traveler passes a pre-primary gate 4012, enters a primary gate/kiosk 4014 and becomes the sole next available traveler for the officer at the associated booth 4016. The primary officer may process the current traveler at the associated booth 4016 and have access to a single next available traveler directly in front of their booth. This provides succinct information for the officer since the officer knows exactly who is coming to the booth next and the next traveler's associated status before calling the traveler. There is no relationship between pre-primary gates/kiosks and primary gates/kiosks. The number of pre-primary gates/kiosks does not need to match the number of primary gates/kiosks. Pre-primary gates/kiosks are optional.

The many-to-many mode shown in 4020 can be used when there are multiple primary gates/kiosks 4014 each associated with multiple primary booths 4016. In this mode, a single officer may pull the next available traveler from any number of primary gates/kiosks 4014 for which they have subscribed (e.g., one primary gate/kiosk, all primary gates/kiosks, a subset of the primary gates/kiosks). This allows the traveler to be seen by the next available officer without having to wait for the officer directly in front of the primary gate/kiosk 4014. This mode can increase user throughput, because a single traveler having issues in the primary gate/kiosk 4014, or at the booth, will not hold up other available travelers.

In one embodiment, a plurality of travelers encounter the pre-primary gates/kiosks 4012. The plurality of travelers may proceed to the primary gates/kiosks 4014 or to a booth 4016 after processing at the pre-primary gates/kiosks 4012. The traveler scans a document at the pre-primary gate/kiosk 4012, and the pre-primary gate/kiosk determines whether the document is sufficient (e.g., contains readable information from an RFID or using MRZ) for further processing at the primary gate/kiosk 4014. The document information is transmitted from the pre-primary gate/kiosk 4012 to the backend processing subsystem and the officer display subsystem. A computer program executed on the backend processing subsystem or the officer display subsystem can manage the flow of travelers as they scan their documents.

In one embodiment, the computer program at the primary gate/kiosk identifies an available indicator (e.g., alphanumeric character, symbol, shape) for the particular traveler to direct that traveler to a new location located between the gate/kiosk and the booth. This location is referred to as an “on-deck” area as the traveler is available for processing by the next available officer. After the officer in the booth 4016 inspects the current traveler at the booth and is ready to receive the next traveler standing in the indicator, the officer will press a button that calls the next traveler, thereby making the next traveler's indicator available for the next traveler at the primary gate/kiosk. The primary gate/kiosk 4012 acknowledges that the indicator is now available and will present an available indicator to a traveler after processing the traveler's document. The primary gate/kiosk manages all indicators assigned to the gate/kiosk and directs travelers to associated indicators once available. If all assigned indicators are occupied by travelers awaiting processing at the booth, the primary gate/kiosk directs the traveler to wait. The officer display subsystem issues a command to the primary gate/kiosk when the officer selects an input on screen resulting in the traveler moving to the booth and the indicator becoming available again.

If the document is not sufficient, the pre-primary gate/kiosk 4012 may instruct the traveler to go to a different lane, speak to a roving officer, or go to a particular booth for processing. If the document is sufficient, a screen of the pre-primary gate/kiosk will display the indicator to direct the traveler. The traveler may use this indicator to proceed to the primary gate/kiosk 4014 or booth 4016 associated with that indicator (e.g., displayed on signage associated with the primary gate/kiosk 4014 or booth 4016). In one embodiment (many-to-many/on-deck), the indicator may be positioned on the floor as a waiting zone (on-deck) for the traveler. When an officer at the booth 4016 is ready to call upon a traveler, the officer can press a button to display on signage of the booth the indicator that is positioned on the floor by the traveler. Having sufficient time to process information about the travelers, the officers can choose a traveler based upon officer preference or in a manner to expedite processing.

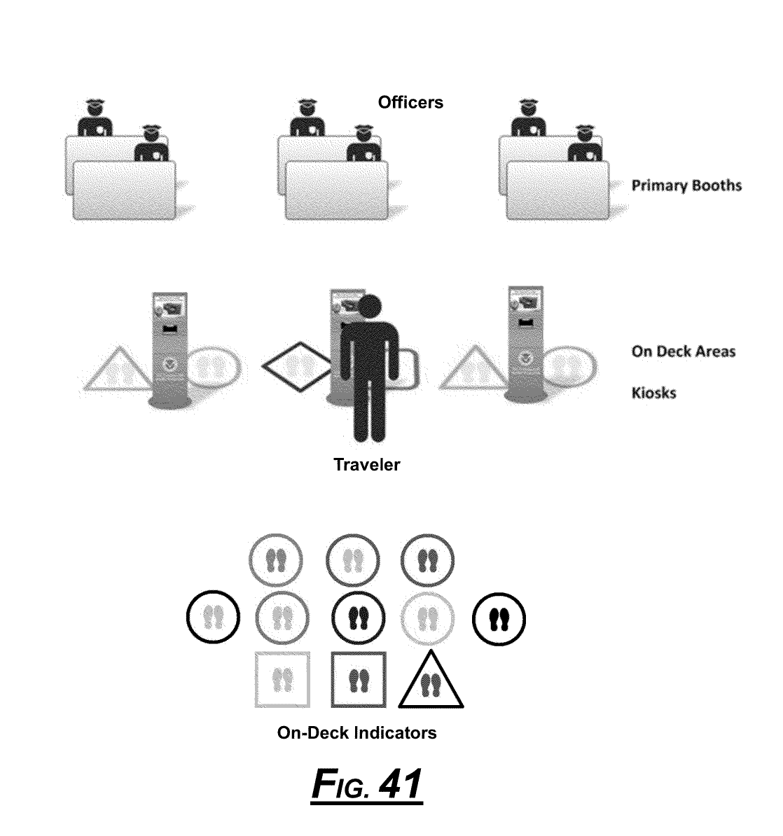

FIG. 41 illustrates various on-deck indicators, along with exemplary indicators in a waiting zone (on-deck areas) near kiosks for travelers before approaching officers at primary booths, according to an exemplary embodiment. Each indicator may have a different shape (e.g., circle, square, triangle) and/or color (e.g., red, yellow, green, blue, black, grey) and/or alphanumeric characters. In this exemplary embodiment, the indicators in FIG. 41 have a footprint to show the traveler where to stand, and each footprint is in the center of a shape having a color.

In a many-to-many mode, a traveler having passed a primary gate/kiosk 4014 needs to stand by one of the indicators in the waiting zone before going to a primary booth. After a traveler passes a primary gate/kiosk 4014, if all indicators are full, the traveler will be told to wait for an open indicator in the on-deck area. Otherwise, if there is one or more open indicators in the waiting zone, the traveler will be sent to an open indicator in the waiting zone, assuming that the traveler is the next one in the queue.

A primary officer in a many-to-many mode can be associated with one or more indicators. For example, a primary officer may be associated with one main indicator in the waiting zone, but can pull people from other indicators if the associated main indicator has no more available travelers to enter or has some traveler not appropriate for the primary officer to process. A more experienced or trained officer can focus on handling travelers with some potential issues. An officer who is in training may only handle travelers with least issues. In the many-to-many mode, officers can balance their workload and help others when one has less work, so that an efficiency of the system can be increased. In addition, the many-to-many mode may serve the travelers better, because each officer who has rich experience dealing one type of issues or travelers can focus on dealing with those issues or travelers only. Therefore, each traveler can be served by an officer who has rich experience in dealing with his/her issues or questions.

When a primary officer calls a specific indicator, the traveler in the specific indicator will be sent to the primary officer's booth, which opens the specific indicator for travelers waiting after the primary gates/kiosks. Then one of the travelers passing the primary gates/kiosks may be chosen to the newly opened indicator, based on some pre-determined criteria. The pre-determined criteria may include the travelers' order of passing the primary gates/kiosks, the travelers' closeness to the newly open indicator, and/or the travelers' potential issues at the primary booth.

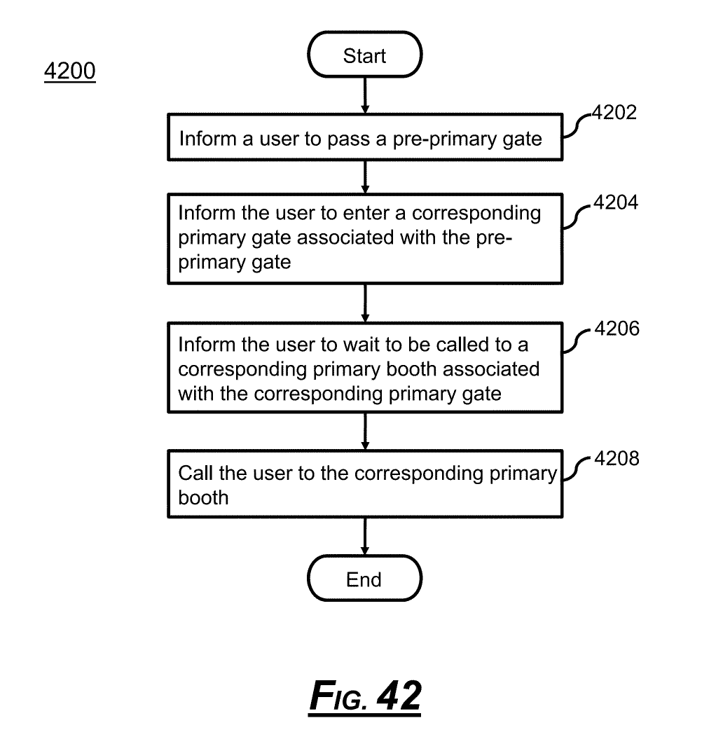

FIG. 42 depicts a flowchart describing a process 4200 for organizing traveling users according to an exemplary embodiment. One of ordinary skill in the art will recognize that the process 4200 may be written using any type of programming language and converted to machine readable instructions. These instructions may be stored in the storage 904 and executed by the processor 902 of the machine 900. The process 4200 corresponds to the one-to-one mode shown in 4010.

At 4202, the process 4200 informs a user to pass a pre-primary gate/kiosk. Since this is a one-to-one mode, there is only one corresponding primary gate/kiosk associated with the pre-primary gate/kiosk the user passed. While the user is proceeding in a queue to the primary gate/kiosk, the backend processing system can check the user's information based on documents the user provided at the pre-primary gate/kiosk. At 4204, the process 4200 informs the user to enter the corresponding primary gate/kiosk, when the user is the next available one in the queue before the corresponding primary gate/kiosk. After the user turns in requested documents at the corresponding primary gate/kiosk, the process 4200 informs the user to wait to be called, at 4206. Again, since this is a one-to-one mode, there is only one corresponding primary booth associated with the primary gate/kiosk the user entered. Therefore, the user waits to be called to the only one corresponding primary booth, following 4206. Then at 4208, the process 4200 calls the user to the corresponding primary booth to see the primary officer.

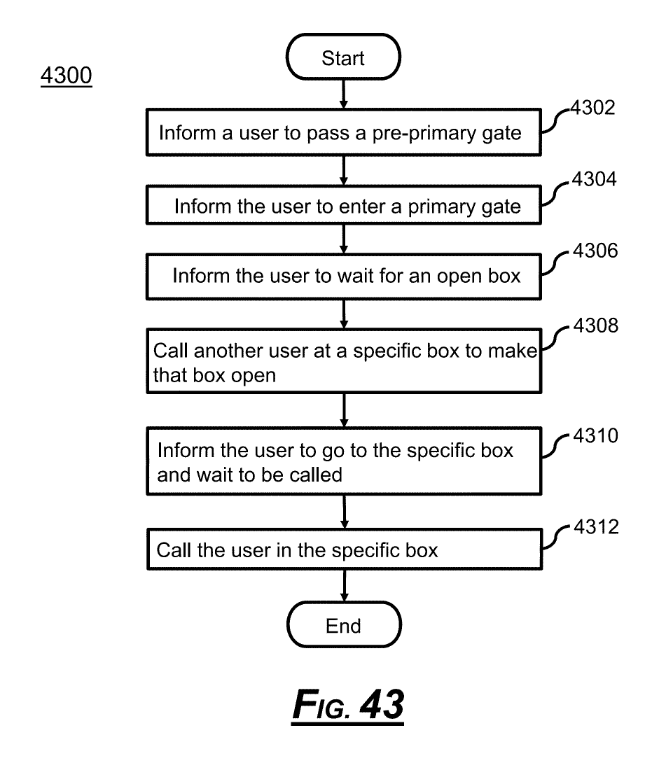

FIG. 43 depicts a flowchart describing another process for organizing traveling users according to an exemplary embodiment. One of ordinary skill in the art will recognize that the process 4300 may be written using any type of programming language and converted to machine readable instructions. These instructions may be stored in the storage 904 and executed by the processor 902 of the machine 900. The process 4300 corresponds to the many-to-many mode shown in 4020.

At 4302, the process 4300 informs a user to pass a pre-primary gate/kiosk. Since this is a many-to-many mode, there is not a specific single corresponding primary gate/kiosk associated with the pre-primary gate/kiosk the user passed. While the user is proceeding in a queue to the primary gate/kiosk, the backend processing system can check the user's information based on documents the user provided at the pre-primary gate/kiosk. At 4304, the user is informed to enter a primary gate/kiosk, maybe one primary gate/kiosk near the user. After the user turns in requested documents at the corresponding primary gate/kiosk, the process 4300 informs the user to wait for an open indicator in a waiting zone, at 4306. At 4308, the process 4300 calls another user at a specific indicator to go to a primary booth and thereby makes that indicator open in the waiting zone. At 4310, the process 4300 informs the user to go to the specific indicator just opened and wait to be called be called, assuming the user is ordered next in the queue before the waiting zone based on some criteria. At 4312, the process 4300 calls the user in the specific indicator to go to a primary booth to see the primary officer.

After a traveler enters a primary gate/kiosk, a kiosk, such as the kiosk described in FIG. 14, described above may ask the traveler to present some documents. A primary officer can view the presented documents via an inspection system monitor. The system may also obtain information related to the traveler from a database based on the presented documents from the traveler. The related information may also be viewed by the primary officer via the inspection system monitor.

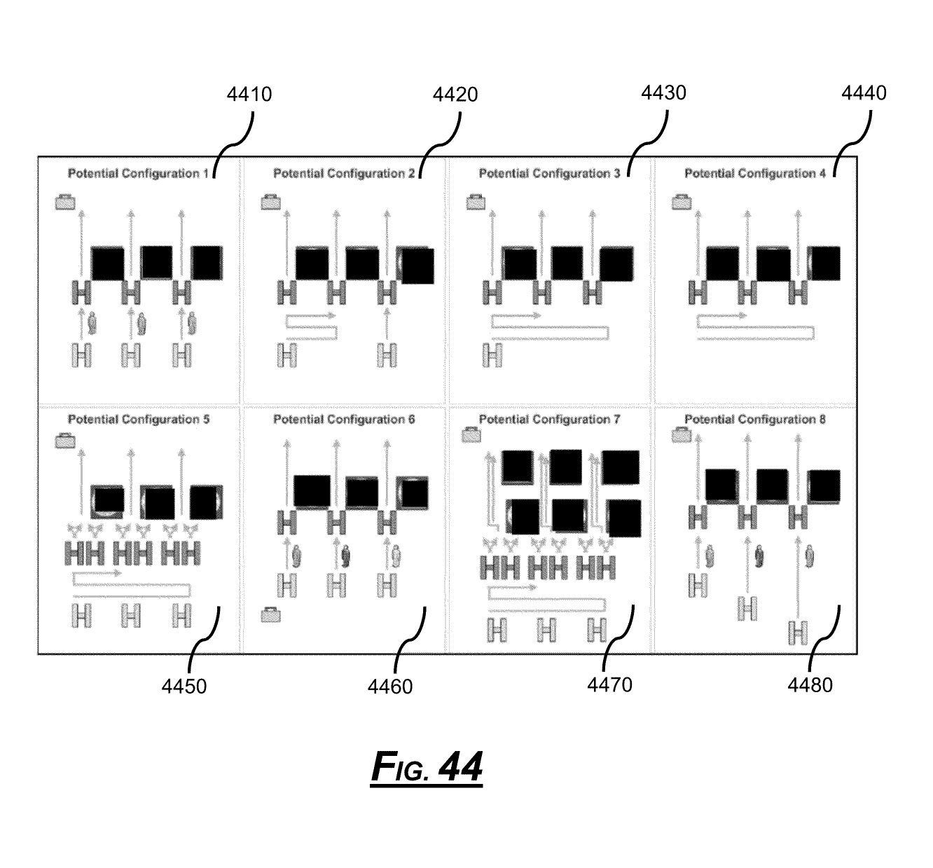

FIG. 44 illustrates various configurations corresponding to various modes of organizing traveling users according to an exemplary embodiment. The configurations in FIG. 44 are not intended to be limiting or prescriptive, but for providing options for each port of entry (POE) to determine an appropriate option for the POE.

The configuration 4410 is the baseline configuration with a single pre-primary gate/kiosk, a single primary gate/kiosk, and a primary booth. Pre-information of the traveler is not known by the officer in the booth while the traveler is in the queuing area but will become available once they enter the primary gate. Pre-information is available to other subscribing officer display subsystems such as the mobile devices used by rovers and management consoles used by supervisors. This configuration corresponds to a one-to-one mode described above. It is listed here again for reference and comparison.

The configuration 4420 represents a lesser number of pre-primary gates/kiosks with optional queuing methods applied for traveler routing. Limiting the number of pre-primary gates/kiosks can provide lower cost impact and less site infrastructure modifications.

The configuration 4430 limits the number of pre-primary gates/kiosks further than configuration 4420, expanding on the ability to minimize cost.

The configuration 4440 limits the number of pre-primary gates/kiosks to zero. It is applicable to those sites which may have limited real estate and the deployment of both pre-primary and primary gates/kiosks is not possible.

The configuration 4450 provides for the many-to-many mode of operation described above. It is listed here again for reference and comparison.

The configuration 4460 represents the ability to enable pre-information for travelers once they enter the queuing area. In this configuration, travelers with various statuses may be reported to subscribing devices in an officer display subsystem. The officers may access the travelers' status and categorize the travelers before they go to the primary gates/kiosks. In addition, the baggage processing may be moved to earlier in the process.

The configuration 4470 shows a combination of configurations including the concept of stacked booths. This configuration allows the facility to optimize space by having officers located in line with each other. Officers in front and back booths may call travelers forward for processing.

The configuration 4480 shows staggered pre-primary gates and pre-information in the queuing area for only those with high alerts. Physical infrastructure or operational parameters may dictate the distance between pre-primary gates/kiosks and primary gates/kiosks.

In one exemplary configuration, the system described herein can be utilized for security at an airport. A kiosk, as described above, has one or more document devices that allows a traveler to read or scan an identification document (e.g., driver's license or passport) and read or scan the traveler's boarding pass, which may include a bar code or QR code, and may be on paper or on a mobile phone. The kiosk transmits this information to a backend processing subsystem to confirm that the traveler's identification document matches the pass. The backend processing subsystem sends the confirmation or rejection of the match to an officer display subsystem. Meanwhile, the traveler proceeds to an officer. At the officer display subsystem, if the match was confirmed, then the officer uses a screen at the officer display subsystem to view the image of the identification document and compare the image to the traveler. The officer may let the traveler proceed after this comparison, thereby eliminating the need for the officer to compare the identification document with the boarding pass, and eliminating the need to ensure that the boarding pass is for a flight that day from that airport. If the match was rejected, the officer can review the documents and make a determination as to how the traveler should proceed.

The exemplary embodiments can include one or more computer programs that embody the functions described herein and illustrated in the appended figures. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “generating” or “determining” or “receiving” or “sending” or “negotiating” or “scanning” or “capturing” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A system for inspecting individuals, the system comprising:
a gate/kiosk subsystem computer configured to receive identifying information from an identification document of an individual;
a signage control subsystem computer configured to display a message on a screen that is visible to individuals prior to an inspection;
a display subsystem computer configured to present the identifying information from the identification document of the individual; and
a backend processing subsystem computer configured to receive additional information about the individual from whom the gate/kiosk subsystem computer received the identifying information from the identification document of the individual.

2. The system according to claim 1, wherein the gate/kiosk subsystem computer comprises a kiosk configured to allow the individual to interact with the gate/kiosk subsystem.

3. The system according to claim 1, wherein the gate/kiosk subsystem computer comprises a document capture device.

4. The system according to claim 3, wherein the document capture device comprises an RFID antenna and reader.

5. The system according to claim 3, wherein the document capture device comprises a machine readable zone reader.

6. The system according to claim 1, wherein the gate/kiosk subsystem computer comprises a biometric capture device.

7. The system according to claim 1, wherein the gate/kiosk subsystem computer comprises a first gate and a second gate.

8. The system according to claim 1, wherein the gate/kiosk subsystem comprises a standing kiosk.

9. The system according to claim 1, wherein the display subsystem computer comprises a handheld computing device.

10. The system according to claim 1, wherein the gate/kiosk subsystem computer comprises a camera configured to provide a video from the gate/kiosk subsystem computer to the display subsystem computer.

11. The system according to claim 1, wherein the gate/kiosk subsystem computer comprises an audio device configured to provide audio from the gate/kiosk subsystem computer to the display subsystem computer and provide audio from the display subsystem computer to the gate/kiosk subsystem computer.

12. The system according to claim 1, further comprising a dashboard system computer configured to receive information related to device defaults, notifications, and heartbeats and to provide control and configuration management of devices.
